(19) United States
(12) Patent Application Publication
(10) Pub. No.: US 2005/0210042 A1
(43) Pub. Date: Sep. 22, 2005

(54) Methods and apparatus to search and analyze prior art

(76) Inventor: James Francis Goedken, Palatine, IL (US)

Correspondence Address: JAMES F. GOEDKEN, 1413 N. LARKSPUR LANE, PALATINE, IL, 60074, US

(21) Appl. No.: 10/805,752

(22) Filed: Mar. 22, 2004

(51) Int. Cl. G06F 7/00

(52) U.S. Cl. 707/100

(57) ABSTRACT

Methods and apparatus to search and analyze prior art are disclosed. The methods and apparatus described herein allow a user to query a large database of prior art documents (e.g., patents) and quickly assess the quality of the patent law specific search results. The query input mechanism is designed around a patent claim metaphor with a group of synonyms representing the scope of each claim element. A patent law specific ranking algorithm is used to find the “best” prior art references. A search results graph is used to refine the search on a claim element specific basis. The final search results are presented as color coded web pages and/or “searchable” PDFs where each element (i.e., synonym grouping) receives a unique color (e.g., Internet and WWW may receive the same color because they represent the same claim element).

### TECHNICAL FIELD

The present application relates in general to database searching and, in particular, to methods and apparatus to search and analyze prior art.

### BACKGROUND

Often, the first step in patenting an invention is performing a search of earlier documents (i.e., prior art) to determine if the invention is new and non-obvious over what was available publicly prior to the time of the invention. Similarly, the first step in determining the validity of an issued patent is usually a prior art search. Typically, a prior art search is performed in one of two ways. These two methods are often referred to as classification searching and keyword searching.

Under the classification method of searching, each document in a database of documents is associated with one or more classes and/or subclasses by a person familiar with the art. For example, an invention related to a web server for hosting thumbnail images generated from uploaded digital photographs may be associated with class 707/104.1 (as well as others) in the U.S. patent classification system. The searcher then selects one or more of the classes and/or subclasses related to the invention he is searching for, and reviews each of the documents in the chosen classes/subclasses. The searcher's review of the documents may include viewing the figures associated with the documents and/or reading some or all of the text associated with each of the documents. This review process may be performed with hard copies of the documents and/or on a computer screen.

The classification searching method has certain drawbacks. In the classification system, a number of classes/subclasses must be created and maintained. For example, the U.S. patent classification system has over 400 classes, and most of these classes have several subclasses. For a large number of documents (e.g., millions of U.S. patents), if the number of classes/subclasses is too small, there are too many documents in each class/subclass to review in a timely manner. If the number of classes/subclasses is too large, determining which classes/subclasses a particular document belongs too becomes complex, and needing to review multiple classes/subclasses can also produce an unmanageable number of documents. Human error potentially plays a role each time a document is classified and each time that document is sought. The classifier may misclassify the document and/or the searcher may not search in the correct class(es). Even if no errors occur, there may be hundreds of legitimate documents that are highly relevant to the search. Manually reviewing hundreds of documents is time consuming.

Under the keyword method of searching, a searcher enters one or more keywords and Boolean operators into a computer which transmits a query to a database. For example, if the invention is related to a web server for hosting thumbnail images generated from uploaded digital photographs, the searcher may enter:
SPEC/(server OR host) AND (thumbnail OR “low resolution image”) AND (upload OR transmit) AND (“digital photograph” OR “digital image”)

The database will then return some or all of the documents it holds that contain at least one occurrence of “server” or “host” and at least one occurrence of “thumbnail” or “low resolution image” and at least one occurrence of “upload” or “transmit” and at least one occurrence of “digital photograph” or “digital image”.

The keyword search method also has certain drawbacks. First, the search iteration cycle is so time consuming, it effectively prohibits extensive “element scoping.” In the example above, the first “element” of the Boolean search is directed to the web server portion of the invention. The searcher may prefer to find “web server” over “server,” because “web server” is narrower (i.e., more on point). However, the searcher probably realizes that “web server” may be harder to find in combination with the other elements than “server.” Similarly, the searcher may prefer “server” over “host” for essentially the same reasons. “Host” seems more likely to be found out of context for this search. In other words, the searcher is typically able to come up with terms that have varying scope from narrow (more desirable/less likely to find) to broad (less desirable/more likely to find), but not knowing what is available in the prior art, the searcher does not know how “greedy” to get with his search terms.

Performing multiple searches with varying scope may be too time-consuming. For example, if each of five elements is varied over three levels of scope, the searcher may have to enter and review 243 separate searches. If the searcher is going to iterate his search at all, he must evaluate the results of each search in order to determine if that iteration is better or worse than iterations that have come before it. Typically, existing searching systems allow the searcher to review various aspects of each document (e.g., title, abstract, specification, and drawings) between search iterations in order to make this determination. However, it is typically up to the searcher to “skim” the document to determine if it is a good one. Skimming an unannotated document can be time consuming and error prone.

In order to review search results in a timely fashion, the searcher typically only reviews the “top” X search results (e.g., the “best” ten). However, this leads to a second problem with keyword searching for prior art; what is “better” than something else? Typically, search results are ranked in some manner before they are displayed to the user. Some systems do not help the searcher determine which results are “better.” For example, some prior art searching systems will simply rank the search results by patent number or filing date.

Other systems will attempt to rank the results based on the number of occurrences of the search terms. While this approach may work for some searching applications, it is fundamentally flawed for prior art searching applications. For example, if a searcher is looking for five different elements (e.g., A, B, C, D, and E) and one prior art reference has one hundred occurrences of A, but only one occurrence of B, C, D, and E, (for a total of 104 occurrences), and a second prior art reference has 20 occurrences of each element A, B, C, D, and E (for a total of 100 occurrences), most patent professionals would rather see the second reference even though it has fewer total occurrences.

If instead, the searching system determined the “better” result by giving each search term a “vote” (e.g., compare occurrences on a term by term basis), the ranking result would be “correct” for the example above because the second prior art reference in the example above “wins” on 4 out of the 5 search terms. However, under a voting system, the ranking result would be “incorrect” for a search result set where the first prior art reference had occurrences of (A=10, B=10, C=10, D=1, E=0) and the second prior art reference had occurrences of (A=9, B=9, C=9, D=100, E=100) because this result would fail to take into account the difference in patent law between “102 art” and “103 art” wherein “103 art” is inferior because it completely lacks an element.

Even if the “103 art” aspect is taken into account by not considering references that do not have at least one occurrences of each search term, there is still a problem with the voting algorithm described above. For example, the voting algorithm would rank a search result set where the first prior art reference had occurrences of (A=10, B=10, C=10, D=1, E=1) higher than a second prior art reference which had occurrences of (A=9, B=9, C=9, D=100, E=100), because the first prior art reference in this example “wins” on 3 out of the 5 search terms. However, most patent professionals would prefer to see the second prior art reference in this example over the first prior art reference; because it appears to be essentially the same as the first prior art reference on the first three elements, but far superior on the last two elements.

A third problem with existing prior art searching systems is that regardless of what ranking method is used, additional synonyms for the same claim element (e.g., A or A′, B or B′ or B″, etc.), are not grouped together by the ranking algorithm. This omission prevents prior art searching systems from employing the logarithmic based ranking approach described in detail below.

A fourth problem with existing prior art searching systems is the time it takes the patent professional to thoroughly analyze the content of each document (e.g., read through the “top ten” documents from the search and determine which one or two of the documents he will use and what sections he will cite). As a result, some systems may highlight each occurrence of the search terms in order to aid the searcher in locating the relevant portions of the document.

However, the highlighting performed by existing systems suffers from two drawbacks. First, existing systems use the same color for all search terms or a different color for every search term. Existing systems do not group synonyms associated with the same claim element under one color while using a different color for other groups of synonyms associated with other claim elements (e.g., A and A′=red, B and B′ and B″=blue). Second, existing systems highlight text versions of the documents. Existing systems do not highlight hypertext versions of the documents or graphical versions of the documents with a text layer “underneath” (e.g., a searchable PDF file).

### BRIEF DESCRIPTION OF THE DRAWINGS

FIG. 1 is a high level block diagram of a communications system.

FIG. 2 is a more detailed block diagram showing one example of a client device.

FIG. 3 is a more detailed block diagram showing one example of a server.

FIG. 4-5 is a flowchart of a process for searching and analyzing prior art.

FIG. 6a is a flowchart of another example process for searching and analyzing prior art.

FIG. 6b is a flowchart of a subject matter diversion detector.

FIG. 7 is a flowchart of an example process for selecting a prior art search firm.

FIG. 8 is a flowchart of an example process for adjusting a score associated with a prior art searching business based on user feedback.

FIG. 9 is a flowchart of an example process for ordering one or more file histories

FIG. 10 is a flowchart of an example process for ordering formal drawings.

FIG. 11 is a flowchart of an example process for ordering translations.

FIG. 12 is a flowchart of an example process for ordering searchable PDFs of patent documents by specific document number.

FIG. 13 is a flowchart of an example process for setting up a patent watchdog.

FIG. 14a is an example of a prior art searching web page.

FIG. 14b is an example of a web page for manually entering “listed” documents.

FIG. 15 is an example of a web page which may be used to collect an invention description letter.

FIG. 16 is an example of a file history order form web page.

FIG. 17 is an example of a formal drawing order form web page.

FIG. 18 is an example of a translations order form web page.

FIG. 19 is an example of a searchable PDF patent order form web page.

FIG. 20 is an example of a watchdog order form web page.

FIG. 21 is an example of a signup web page.

FIGS. 22-24 are example pages of a color coded PDF document.

FIGS. 25-26 are example pages of a color coded HTML document rendered by a web browser.

### DETAILED DESCRIPTION OF EXEMPLARY EMBODIMENTS

In general, the methods and apparatus described herein allow a user to query a large database of prior art documents (e.g., patents) and quickly assess the quality of the patent law specific search results. The query input mechanism is designed around a patent claim metaphor with a group of synonyms representing the scope of each claim element. A patent law specific ranking algorithm is used to find the “best” prior art references. A search results graph is used to refine the search on a claim element specific basis. The final search results are presented as color coded web pages and/or “searchable” PDFs where each element (i.e., synonym grouping) receives a unique color (e.g., Internet and WWW may receive the same color because they represent the same claim element).

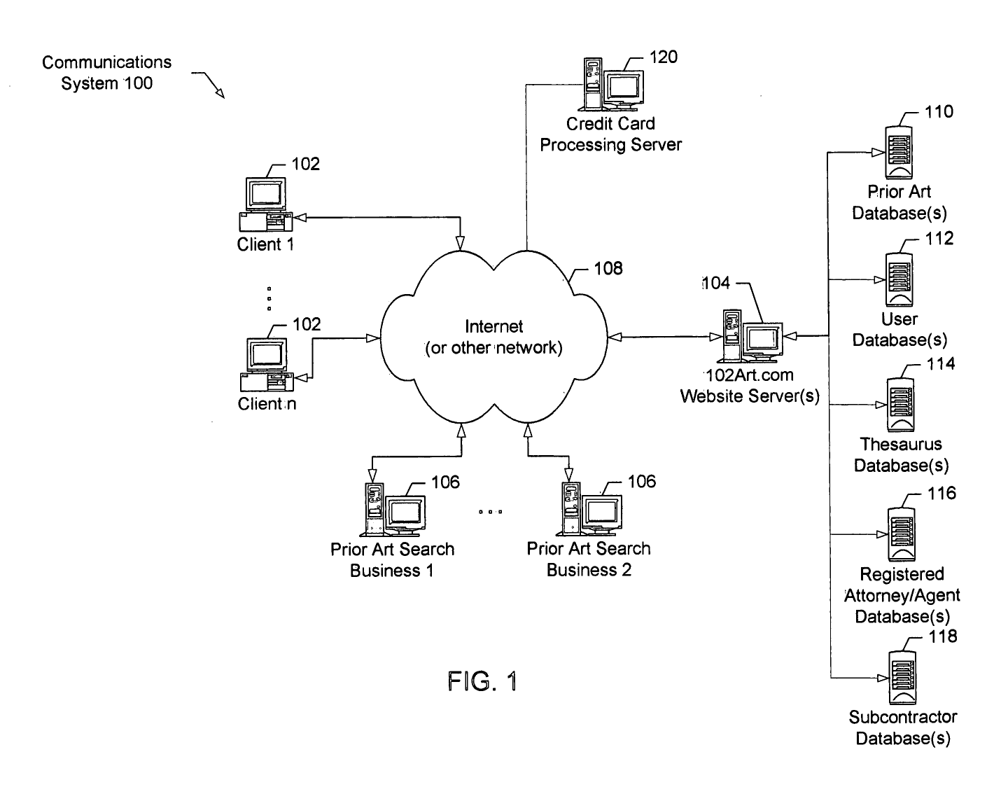

A high level block diagram of an exemplary network communications system 100 is illustrated in FIG. 1. The illustrated system 100 includes one or more client devices 102, one or more website servers 104, and one or more prior art search business computers 106. Each of these devices may communicate with each other via a connection to one or more communications channels 108 such as the Internet or some other network.

The website server 104 stores a plurality of files, programs, and/or web pages for use by the client devices 102 and/or the business computers 106. In particular, the website server 104 is connected to one or more prior art databases 110. The prior art database 110 may be connected directly to the website server 104 and/or via one or more network connections. The prior art database 110 stores a plurality of documents. The documents may be of any type and may be stored in any format. For example, the prior art database 110 may store a plurality of text files, HTML files, XML files, TIFF files, PDF files, etc. indicative of issued patents, published patent applications, foreign publications, magazine articles, etc.

In addition, the website server 104 may be connected to one or more user databases 112. The user database 112 preferably stores information related to users of the server 104. For example, the user database 112 may store login information (e.g., user name, e-mail address, and password), contact information (e.g., name, address, and phone number), payment information (e.g., credit card number and expiration date), and search information (e.g., docket numbers, search terms, and document identifiers).

In addition, the website server 104 may be connected to one or more thesaurus databases 114. The thesaurus database 114 preferably stores a plurality of index words. Each of the index words is then logically associated with a plurality of synonyms for the index word. For example, the index word “computer” may be associated with the synonyms “processor, CPU, central processing unit, mainframe, workstation, PC, laptop, etc.”

In addition, the website server 104 may be connected to one or more registered attorney/agent databases 116. The registered attorney/agent database 116 preferably stores a plurality of records representing registered patent attorneys and agents. The information stored in each record preferably includes contact information associated with a registration number. The website server 104 may use this data to automatically fill contact information into sign up fields based on a given registration number in order to save the user from entering the information manually.

In addition, the website server 104 may be connected to one or more subcontractor databases 118. The subcontractor database 118 preferably includes information associated with contractors for services such as prior art searching, formal drawing preparation, language translation, file history retrieval, etc. In addition, preferences, scores, ranks, etc. associated with the subcontractors may be stored.

One server 104 may interact with a large number of clients 102 and business computers 106. Accordingly, each server 104 is typically a high end computer with a large storage capacity, one or more fast microprocessors, and one or more high speed network connections. Conversely, relative to a typical server 104, each client device 102 and each business computer 106 typically includes less storage capacity, a single microprocessor, and a single network connection.

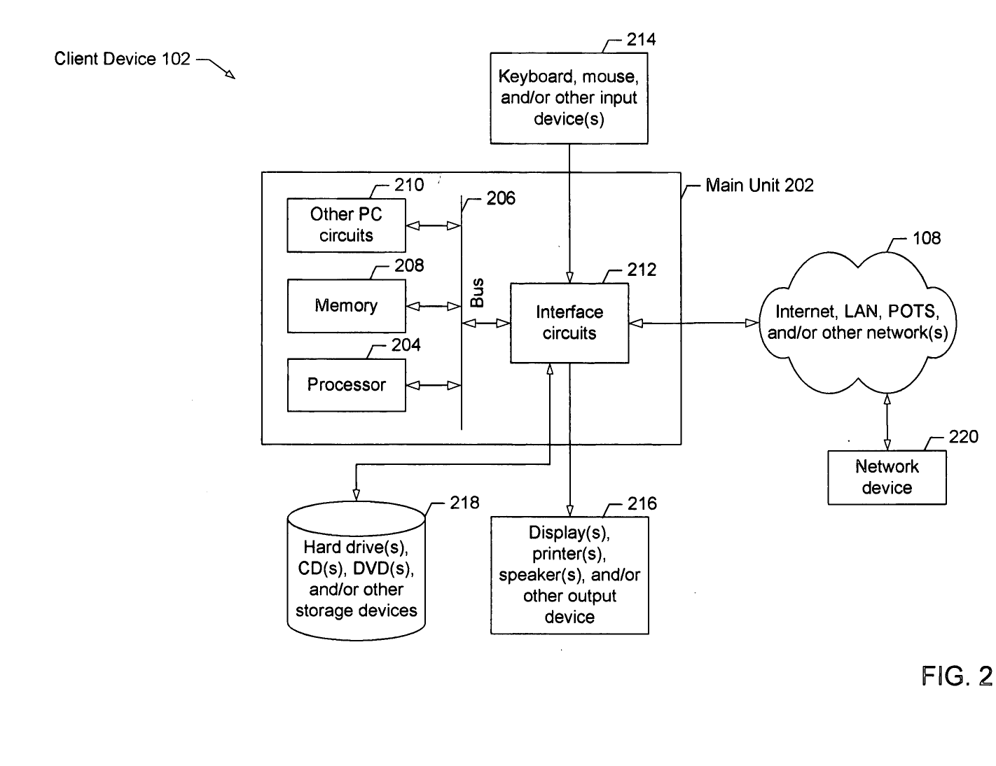

A more detailed block diagram of a client device 102 is illustrated in FIG. 2. The client device may be a personal computer (PC), a personal digital assistant (PDA), an Internet appliance, a cellular telephone, or any other communication device. The client 102 includes a main unit 202 which preferably includes one or more processors 204 electrically coupled by an address/data bus 206 to one or more memory devices 208, other computer circuitry 210, and one or more interface circuits 212. The processor 204 may be any type of well known processor, such as a microprocessor from the Intel Pentium® family of microprocessors. The memory 208 preferably includes volatile memory and non-volatile memory. Preferably, the memory 208 stores a software program that interacts with the other devices in the system 100 as described below. This program may be executed by the processor 204 in a well known manner. The memory 208 may also store digital data indicative of documents, files, programs, web pages, etc. retrieved from a server 104, a business computer 106 and/or loaded via an input device 214.

The interface circuit 212 may be implemented using any type of well known interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client 102. For example, the display 216 may be used to display web pages received from the server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the client 102.

The client 102 may also exchange data with other network devices 220 via a connection to the network 108. The network connection may be any type of network connection, such as an Ethernet connection, digital subscriber line (DSL), telephone line, coaxial cable, etc. Users of the system 100 (such as a patent attorney, patent agent, prior art searching professional, inventor, or other users) may be required to register with the server 104. In such an instance, each user may choose a user identifier (e.g., e-mail address) and a password which may be required for the activation of services. The user identifier and password may be passed across the network 108 using encryption built into the user's browser. Alternatively, the user identifier and/or password may be assigned by the server 104.

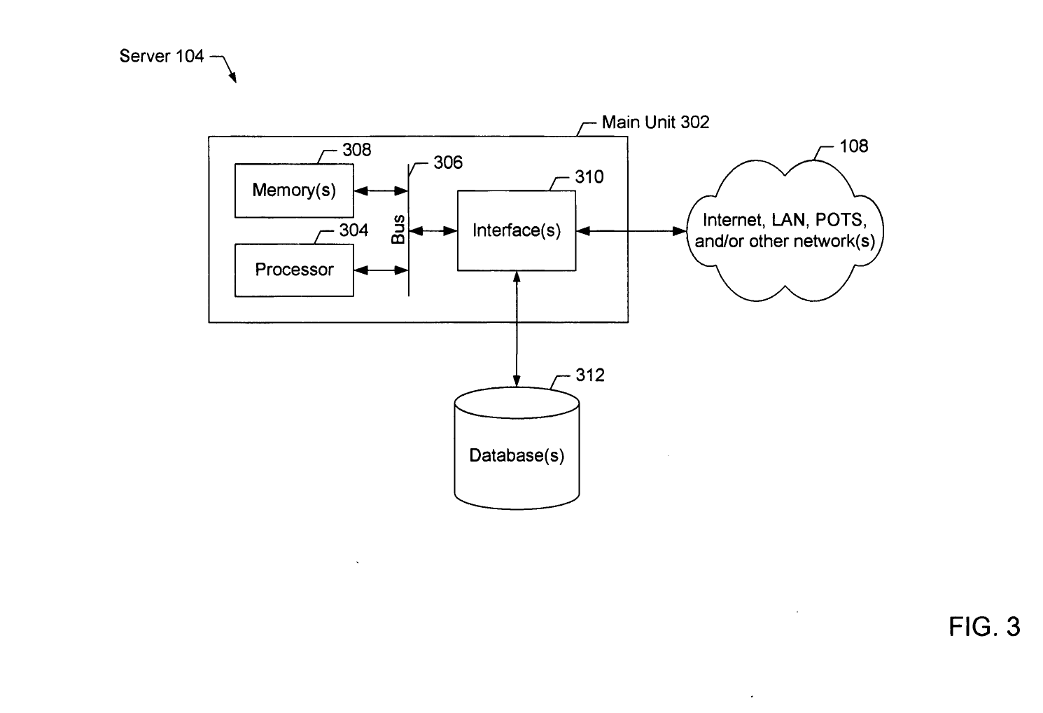

A more detailed block diagram of a server 104 is illustrated in FIG. 3. Like the client device 102, the main unit 302 in the server 104 preferably includes a processor 304 electrically coupled by an address/data bus 306 to a memory device 308 and a network interface circuit 310. The processor 304 may be any type of well known processor, and the memory device 308 preferably includes volatile memory and non-volatile memory. Preferably, the memory device 308 stores a software program that implements all or part of the method described below. This program may be executed by the processor 304 in a well known manner. However, some of the steps described in the method below may be performed manually or without the use of the server 104. The memory device 308 and/or a separate database 312 also store files, programs, web pages, etc. for use by other servers 104, business computers 106, and/or client devices 102. Preferably the database 312 stores prior art, user information, thesaurus data, search data, attorney/agent registration information, subcontractor data, and other data.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

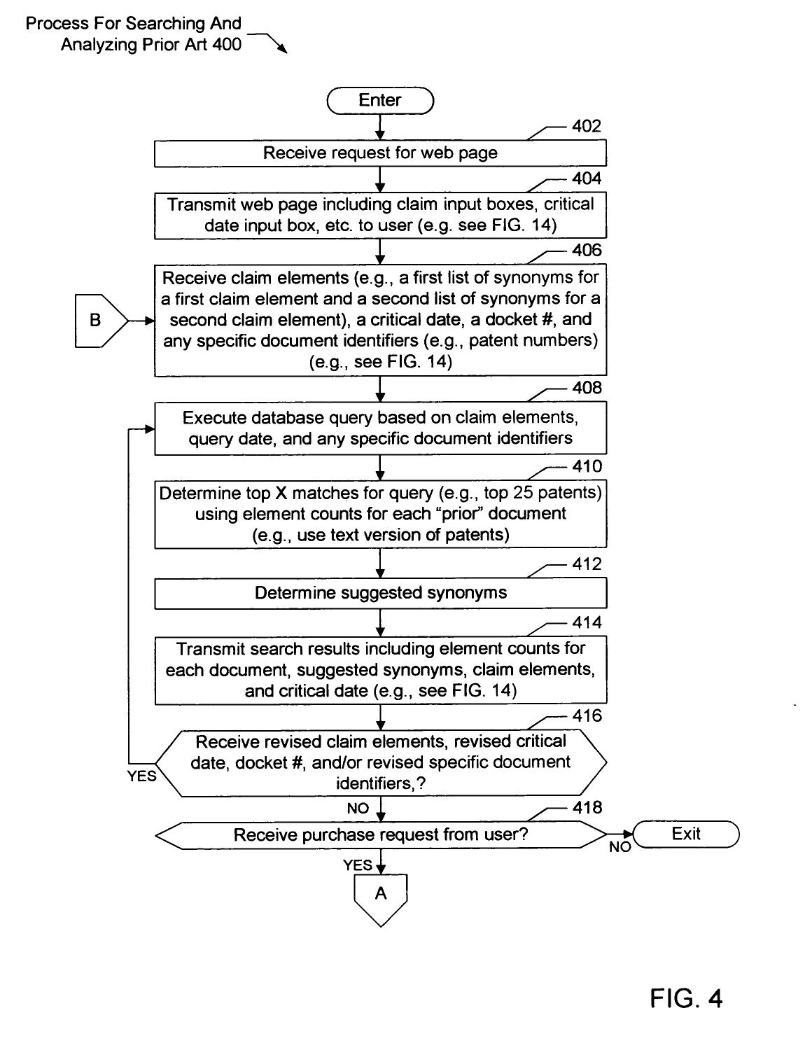

A flowchart of an example process 400 for searching and analyzing prior art is illustrated in FIG. 4. Preferably, the process 400 is embodied in one or more software programs which is stored in one or more memories and executed by one or more processors. Although the process 400 is described with reference to the flowchart illustrated in FIG. 4, a person of ordinary skill in the art will readily appreciate that many other methods of performing the acts associated with process 400 may be used. For example, the order of many of the steps may be changed. In addition, many of the steps described are optional. In addition, although the examples used herein are directed to prior art searching, a person of ordinary skill in the art will readily appreciate that the techniques disclosed herein may be applied to other types of searching. For example, the techniques disclosed herein may be used to search for and/or color code web pages and/or any other type of document.

Generally, the process 400 allows a user to query a large database of prior art documents (e.g., patents) and quickly assess the quality of the patent law specific search results. The query input mechanism is designed around a patent claim metaphor with a group of synonyms representing the scope of each claim element. A patent law specific ranking algorithm is used to find the “best” prior art references. A search results graph is used to refine the search on a claim element specific basis. The final search results are presented as color coded HTMLs and/or “searchable” PDFs where each element (i.e., synonym grouping) receives a unique color (e.g., Internet and WWW may receive the same color because they represent the same claim element).

The process 400 begins when the website server 104 receives a request for a web page from a client device 102 (block 402). For example, a user may request the home page of a prior art website. In response, the website server 104 transmits a prior art searching web page to the client device 102 (block 404).

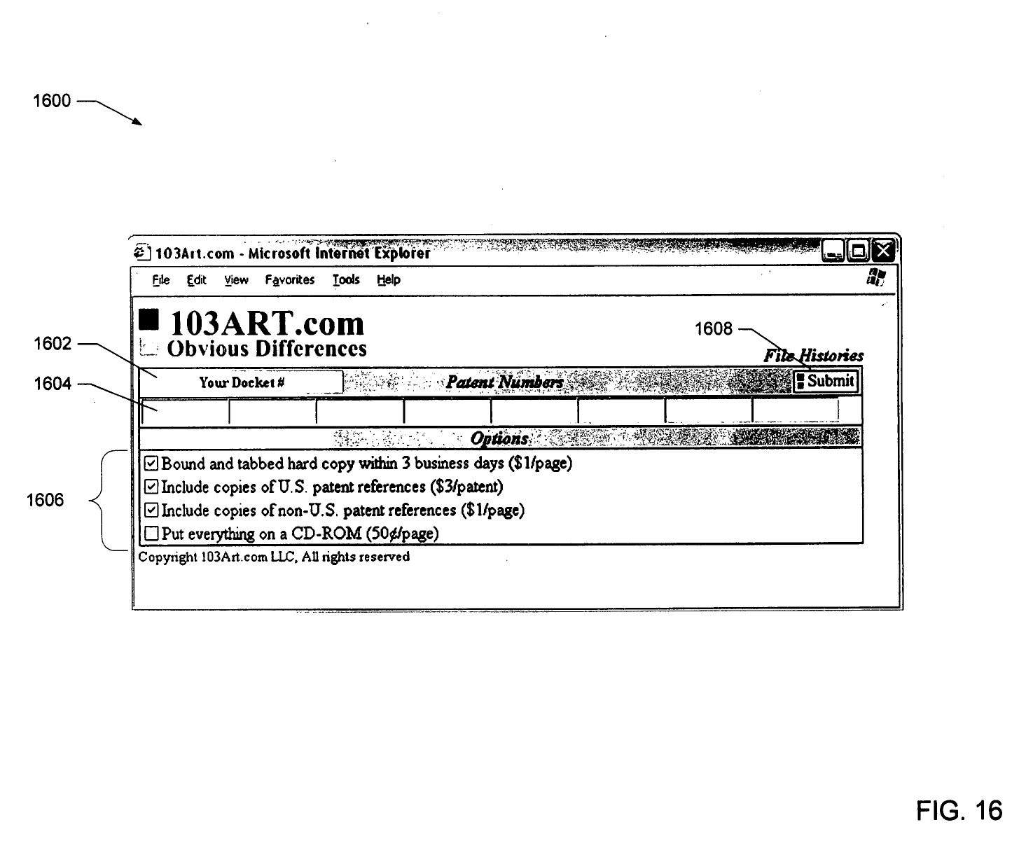

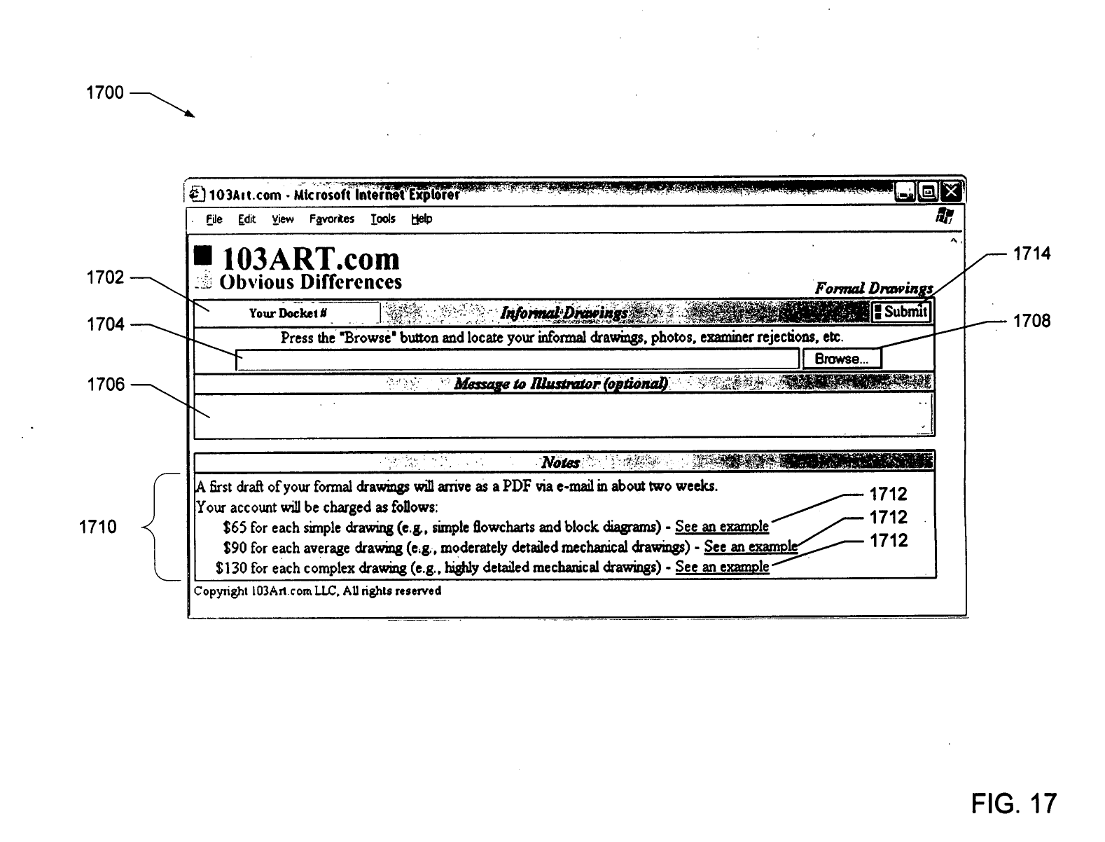

An example of a prior art searching web page 1400 is illustrated in FIG. 14a. Preferably, the prior art searching web page 1400 includes a docket number input box 1402, a critical date input box 1404, a plurality of claim input boxes 1406, a plurality of document identifier output boxes 1408, and a plurality of chart output boxes 1410. The user enters/modifies the data in one of more of the input boxes on the web page 1400 and sends the data to the web server 104 by pressing a “Search” button 1412.

The user may enter a docket number in the docket number input box 1402 in order to identify a search. Preferably, the server 104 stores a unique identifier associated with the user (e.g., customer number or e-mail address) and the docket number in association with saved versions of the user's search queries in the user database 112. For example, the server 104 may save user search data automatically each time a search is performed, when the user presses a “Save” button 1422, and/or when the user presses a “Purchase” button 1416. In this manner, correspondence between the server 104 and the user may be identified, and previously conducted searches may be retrieved using an “Open” button 1424. Of course, retrieved searches may be modified and re-executed.

The user may enter a critical date in the critical date input box 1404 in order to limit the scope of the available prior art. For example, the search results presented to the user preferably exclude patents with a filing date that is after the critical date entered by the user. By default, the critical date is preferably set by the server 104 or the client 102 to be the current date. However, if the user enters a critical date or a docket number previously associated with a critical date, that critical date is used by the server 104 for the search query.

The user may enter a list of synonyms for each of a plurality of claim elements in the claim input boxes 1406. Each synonym may be a text string representing a single word (e.g., Internet) or a word phrase (e.g., world wide web). Preferably, each synonym is separated by a delimiter (e.g., a comma) or each synonym is entered into a separate input box. Preferably, the user is not required to use quotes around word phrases and/or Boolean logic symbols (e.g., AND, &, OR, ∥) between synonyms or claim elements.

To assist the user in entering synonyms for a claim element, the web page 1400 preferably suggests one or more synonyms via a thesaurus tool 1414. In the illustrated example, the thesaurus tool 1414 is a context sensitive drop down box. The list of synonyms in the drop down box changes based on which claim input box 1406 gains focus and/or which word(s) are currently selected. In the illustrated example, the thesaurus tool 1414 might suggest network, intranet, and/or WAN as additional synonyms for the first claim element. If the user selects one of the words in the thesaurus tool 1414, the web page 1400 preferably places the selected word in the current claim element input box 1406 and removes that choice from the thesaurus tool 1414. In addition, if the user manually enters a synonym that is also in the thesaurus tool 1414, the web page 1400 preferably removes that choice from the thesaurus tool 1414 automatically. Conversely, if the user deletes a word/phrase from a claim element input box 1406 that is otherwise supposed to be displayed by the thesaurus tool 1414, the thesaurus tool 1414 may insert that word/phrase into the drop down list.

Preferably, the words and/or phrases listed by the thesaurus tool 1414 are updated by the server 104. For example, each time a prior art search is updated, the server 104 may supply a data structure to the client 102 that lists a plurality of suggested synonyms for each claim element. For example, if the user enters “computer, PDA, cellular telephone” for the first claim element, the server 104 may query a database to retrieve a first list of synonyms for “computer”, a second list of synonyms for “PDA”, and a third list of synonyms for “cellular telephone”. Preferably, the server 104 combines the separate lists (three in this example), removes duplicates, and prioritizes synonyms that occurred in relatively more lists over synonyms that occurred in relatively less lists. This preferencing may be used, for example, to shorten the overall list of suggested synonyms and/or to place higher priority synonyms in a more prominent light (e.g., higher in the list, in bold, etc.).

The document identifiers inside the document identifier input boxes 1408 may be generic ranking numbers generated by the system (e.g., Document 1, Document 2, Document 3, . . . ), or the document identifiers may be more specific numbers (e.g., 1: 6332146) either generated by the system or entered as inputs by the user. Preferably, the system searches for the “best” results and identifies each document with a ranking number until the documents are purchased. Once the documents are purchased, the specific document identifiers (e.g., patent numbers) may be used. In this manner, the user may see how many occurrences of each claim element are present (as defined by the user's synonym lists) before the user purchases the search results.

Purchased search results are preferably “graylisted” automatically. Optionally, the user may also manually enter a plurality of document identifiers (e.g., patent numbers) to be “graylisted,” “whitelisted,” or “blacklisted.” For example, the user may navigate to a web page 1450 (see FIG. 14b) for entering a plurality of “listed” document identifiers by pressing a “Listed” button 1426.

A blacklisted document is not included in the search results. For example, if the user is already aware of certain documents, and does not want to see search results that include those documents, the user may chose to blacklist those documents.

A whitelisted document is always included in the search results (even if it is not ranked in the top x search results) and is identified by a specific document identifier (e.g., 1: 6332146) as opposed to a generic document identifier (e.g., Document 1). Preferably, whitelisted documents are placed in the search results at the correct rank. For example, a whitelisted document that would not otherwise have been included in the top 25 documents may be placed at position 25. Whitelisting may be used if the user is aware of a document that he would like to compare to the other search results. Similarly, whitelisting may be used to have one or more known documents color coded (as described in detail below).

A graylisted document is identified by a specific document identifier (e.g., 1: 6332146) in the search results if the graylisted document “makes” the search results (e.g., if it really is in the top 25 without being forced in like a whitelisted document). In this manner, the user may avoid purchasing documents he is already aware of without forcing the list to artificially exclude those documents. For example, after the user has already purchased documents, he may want to check if a new search produces higher ranking results than his already purchased search.

Preferably, these lists (e.g., black, gray, and white) are associated with a particular user and/or docket number. In this manner, “listed” documents for one user and/or docket number do not affect another user and/or docket number. Optionally, one or more of these lists may be associated with a group of users, such as a firm or company. In this manner, a team of people working on the same docket number may benefit from each other's lists. Similarly, one or more of these lists may be associated with a group of docket numbers, such as all docket numbers associated with a particular client. In this manner, a team of people working on different docket numbers for the same client may benefit from each other's lists.

An example, of a web page 1450 for manually entering “listed” documents is illustrated in FIG. 14b. In the illustrated example, the web page 1450 includes a docket number input box 1452, a plurality of document identifier input boxes 1454, and a plurality of listing-type selection options 1456. Preferably, the docket number in the docket number input box 1452 is entered automatically based on the docket number entered in the docket number input box 1402 of the prior art searching web page 1400. In addition, any document identifiers currently associated with this user and the automatically entered docket number are retrieved and displayed along with the associated selections for the listing-type selection options 1456. However, the user may override the automatically entered docket number by entering any docket number in the docket number input box 1452. The user may enter/modify the data in one of more of the document identifier input boxes 1454 and/or the associated listing-type selection options 1456. The data may be sent to the web server 104 by pressing a “Save” button 1458.

The user may sort the document identifiers and the associated listing-type selections by pressing a sort button 1460. Preferably, the sort button 1460 changes appearance when it is pressed. In one state, the sort button 1460 indicates the user may sort the “listed” documents numerically by document identifier. In another state, the sort button 1460 indicates that the user may sort the “listed” documents by list type (e.g., by color). In addition, the user may sort on any one of the columns by clicking in the column header 1462, 1464, 1466, 1468. For example, the user may sort the “listed” documents numerically (or alphanumerically) by document identifier by clicking in the document identifier header 1462. Similarly, clicking in a “black” header 1464 preferably sorts the “listed” documents by list type with the blacklisted documents being shown first. Clicking in a “gray” header 1466 preferably sorts the “listed” documents by list type with the graylisted documents being shown first. Clicking in a “white” header 1468 preferably sorts the “listed” documents by list type with the whitelisted documents being shown first.

Returning to FIG. 14a, the chart output boxes 1410 are used to display a graphical representation of the search results. In this example, a bar chart is used. However, any type of representation may used to summarize the search results. As described above, each claim element may be represented by a plurality of synonyms. Preferably, the graphical results aggregate the occurrences of each of the synonyms representing a single claim element. For example, if a claim element is represented by “Internet, www, network”, and a first prior art document contained five occurrences of “Internet”, two occurrences of “www” and one occurrence of “network”, the graphical element representing that element of that prior art document would represent a value of eight. Similarly, a second prior art document containing three occurrences of “Internet”, three occurrences of “www” and two occurrences of “network”, would also be represented by a value of eight in this example. Preferably, each aggregated claim element is represented by a different color, and the color scheme remains consistent from one prior art document to the next.

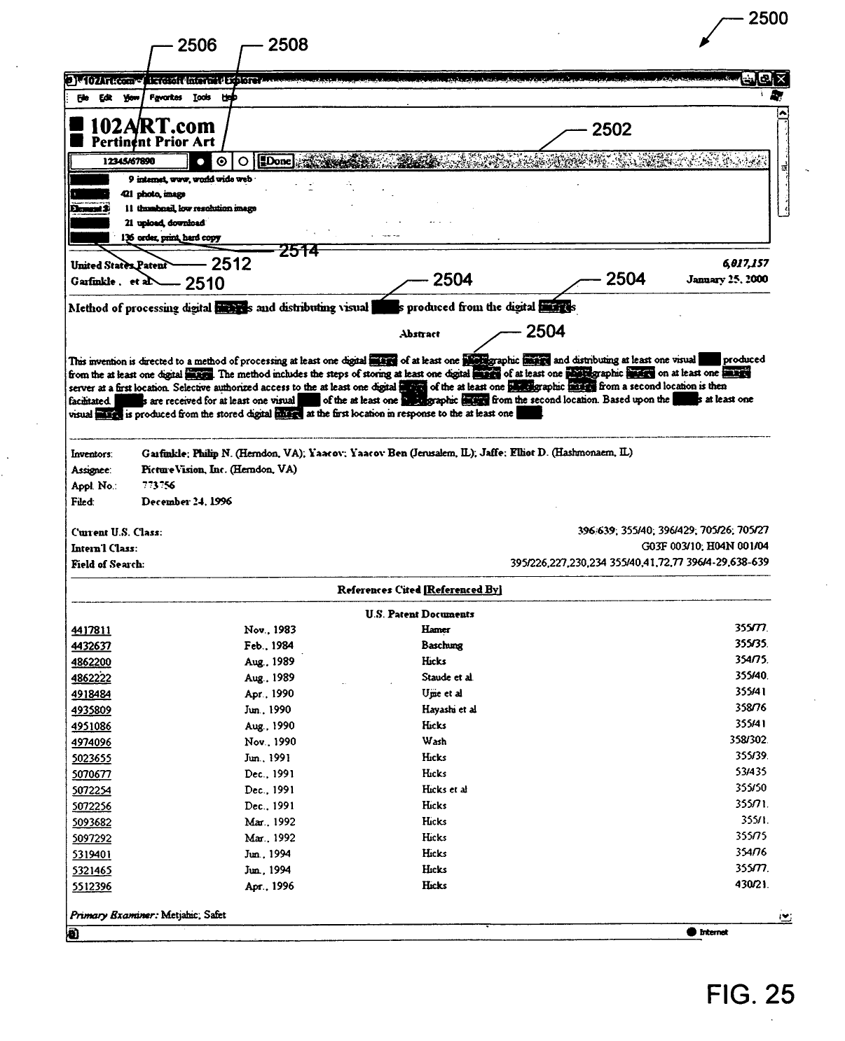

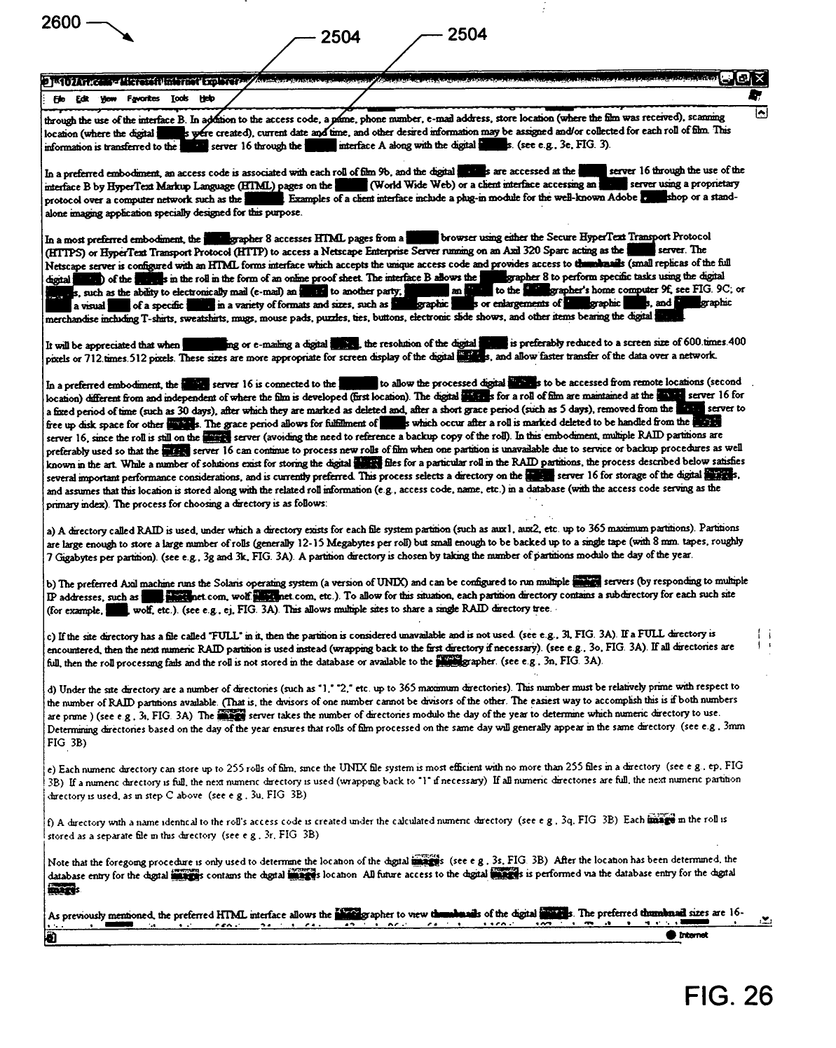

A “Purchase” button 1416 may be used to purchase color coded versions of the documents represented by the chart output boxes 1410. Preferably, the document identifier boxes 1408 do not reveal the true document identifiers until the search results have been purchased or the documents have been “listed.” For example, ranking numbers may be shown until the search results are purchased. Then, the ranking numbers may be replaced by patent numbers. Once the user reveals a document identifier, the document identifier preferably includes a hyperlink to a color coded version of the document. An example of a color coded document in PDF format is illustrated in FIGS. 22-24. An example of a color coded document in HTML format is illustrated in FIGS. 25-26.

Returning to FIG. 14, the web page 1400 may also include arrows 1418a, 1418b and/or other types of user input areas (such as scroll bars) to scroll through additional graph data. Preferably, the purchase button 1416 changes to display an increasing price as the user displays an increasing number of search results. For example, the purchase button 1416 may indicate the price for the top five search results is $100. When the user clicks the right arrow button 1418b, the purchase button 1416 may indicate the price for the top ten search results is $175. If the user returns to displaying the top five results by clicking the left arrow button 1418a, the purchase button 1416 again indicates that the price for the top five search results is $100.

Similarly, the web page 1400 may include arrows 1420 and/or other types of user input areas (such as scroll bars) to scroll through and/or add additional rows to the search grid. As shown, each row preferably includes a claim input box 1406 and a plurality of chart output boxes 1410.

The web page 1400 may also include arrows 1428a, 1428b and/or other types of user input areas (such as tabs) to flip from the current search inputs to previous search inputs. The previous search inputs may be stored automatically and/or in response to a user save command. Preferably, reverting to a previous set of inputs changes all of the user inputs including the claim elements, critical date, docket number, etc. When the user reverts to an earlier input set, the web page 1400 preferably updates the outputs to match. For example, previous search inputs and outputs may be stored locally by the client 102 with a local script executing the update without the need to access the server 104. Again, all outputs are preferably updated including the document identifier output boxes 1408, the chart output boxes 1410, and the thesaurus tool 1414.

Returning to FIG. 4, once the user's data is received by the server 104 (block 406), the server 104 executes one or more database queries using the claim elements, critical date, docket number, and/or specific document identifiers entered by the user (block 408). Preferably, the database query is executed by a stored procedure which examines every document in the prior art database 110 that is “prior” to the critical date entered by the user (or the default critical date). In the case of patent documents in the prior art database 110, the filing date of the patent is used to determine if the patent is prior to the critical date in order to take into account 35 U.S.C. §102(e). In the case of other documents (e.g., a magazine article), the date of publication is used to determine if the document is prior to the critical date in order to take into account 35 U.S.C. §102(a).

Each prior art document is examined in order to determine a top X group of documents (e.g., top 25) (block 410). When ranking the documents, the number of occurrences of each word and/or phrase entered by the user in the claim input boxes 1406 is preferably counted. In one example, documents with a zero count for one of the elements rank lower than documents with no zero count elements. Similarly, documents with a zero count for two of the elements rank lower than documents with only one zero count element, and so on.

In order to increase the speed of the search, the process 400 may compare the number of zero count elements in a document under test to the largest number of zero count elements present in the top X table (e.g., if the top 10 documents are being sought, the number of zero count elements in the document currently holding 10^{th} place) after each element in the document under test is counted. If the number of zero count elements in the document under test already exceeds the largest number of zero count elements present in the top X table, the rest of the elements of the document under test need not be counted. Therefore, the process 400 can skip to the next document to save time.

In order to further increase the speed of the search, the process 400 may start by testing the previous top X documents before searching the rest of the database of documents. Because the current search terms are often very similar to the previous search terms, the largest number of zero count elements present in the top X table is more likely to quickly reach a low number than if the database of documents was simply searched in some other order (e.g., numeric order). As a result, the number of zero count elements in each subsequent document under test is more likely to exceed the largest number of zero count elements present in the top X table before all of its elements are searched, and the process 400 can skip searching many of the elements of many of the documents to save time.

For documents with the same number of zero count elements, a score is preferably assigned in order to determine a document's rank within its zero count grouping. For example, assume the user enters three claim elements (a, b, and c), with three synonyms representing each element (a1-a3, b1-b3, and c1-c3). If A1 represents the number of occurrences of a1 in a document, and A2 represents the number of occurrences of a2 in the document, etc., a score may be assigned by summing the logarithms of the total occurrences for each element [e.g., score=log(A1+A2+A3)+log(B1+B2+B3)+log(C1+C2+C3)]. Higher scores rank higher than lower scores.

In this manner, the first few occurrences of a claim element are given more weight than the last few occurrences. For example, log(20) is not twice as much as log(10), therefore the first ten occurrences contribute a total of 1 point to the overall score, while the second ten occurrences only contribute a total of 0.301 points to the overall score. This gives some importance to having more occurrences of an element, but tends to rank “balanced” documents (e.g., A=10, B=10, C=10; score=3.00) higher than “lopsided” documents, even if the lopsided document has a larger number of total occurrences (e.g., A=100, B=5, C=1; score=2.70) or “wins” a vote on a majority of elements (e.g., A=12, B=12, C=2; score=2.46).

In order to avoid a log(0) problem, each zero count element preferably contributes zero points to the score. This may be accomplished by skipping zero count elements when calculating the score, artificially increasing the number of occurrences of zero count elements to one occurrences (i.e., log(1)=0), artificially increasing the number of occurrences of all element counts by one, etc.

In some contexts, instead of counting the number of occurrences of each word and/or phrase entered by the user in the claim input boxes 1406, the server 104 may first translate each word and/or phrase entered by the user into a language associated with the document being searched. The language of the document being searched may be predetermined and stored in association with the document, or the text of the document may be examined and compared to a language database to determine the language of the document. By translating each word and/or phrase entered by the user into a language associated with the document being searched, prior art in one language may be searched by persons using another language. In addition, the server 104 may prepare color coded versions of those documents (as described below) based on the translated user inputs. In addition, a machine translation of some documents may be provided to the user. If the user determines that a “foreign” document warrants the expense, the user may have some or all of the document translated by a professional.

In an alternate embodiment, the user may enter more than one list of synonyms for each of the claim elements. For example, the web page 1400 may provide an A-list input box, a B-list, and a C-list input box for each claim element (e.g., 15 input boxes for 5 elements). Preferably, the user would enter “narrow” synonyms in the A-list input box (e.g., Internet), “broad” synonyms in the C-list input box (e.g., network), and medium scope synonyms in the B-list input box (e.g., wide area network). In addition, the user may enter a threshold number of occurrences (e.g., >10 for each element), and the number of documents the user prefers to find (e.g., top 5). In such an instance, the search algorithm preferably iterates through combinations of lists (e.g., starting with the most desirable A-lists and working toward the least desirable C-lists) until the threshold condition is met for the specified number of documents. In this manner, the search algorithm may automatically broaden the scope of certain elements as needed based on the state of the prior art, the desired threshold, and the desired number of documents. Typically, setting a lower threshold and/or requesting fewer documents, results in narrower (more desirable) synonyms being used to represent one or more claim elements. Conversely, setting a higher threshold and/or requesting more documents, results in broader (less desirable) synonyms being used to represent one or more claim elements.

For example, assume 1A represents an A-list of synonyms for element 1, and 2A represents an A-list of synonyms for element 2, and 3A represents an A-list of synonyms for element 3, and 1B represents a B-list of synonyms for element 1, and 2B represents a B-list of synonyms for element 2, etc. Also assume the threshold value is set to T. The search algorithm preferably starts by using 1A, 2A, and 3A. The documents are preferably ranked as described above. If the number of occurrences for all of the elements of the top X documents (where X may be predefined or set by the user) exceed the threshold T, then the search iteration may stop. However, if the threshold criteria are not met, the search algorithm preferably performs three more searches (in this example). One of the additional searches uses 1A+1B, 2A, and 3A; another search uses 1A, 2A+2B, and 3A; another search uses 1A, 2A, and 3A+3B (i.e., each element is broadened separately by combining the A-list and the B-list for that element). If more than one of theses searches meets the threshold criteria, the “best” search (as determined by the log based scores) is selected. If none of theses searches meets the search criteria, another series of iterations is performed (e.g., 1A+1B, 2A+2B, 3A; 1A+1B, 2A, 3A+3B; and 1A, 2A+2B, 3A+3B).

If the search algorithm reaches the broadest possible list of synonyms (e.g., 1A+1B+1C, 2A+2B+2C, 3A+3B+2C) without meeting the threshold criteria, the search algorithm may automatically reduce the threshold value T, reduce the number of documents criteria, and/or report an “error” message to the user. If the threshold value T and/or the number of documents criteria is automatically reduced, the search algorithm is preferably rerun automatically using the reduced criteria. Of course, the search results produced on earlier runs of the algorithm may be saved to prevent the need to rerun them.

In addition to the prior art database queries, the server 104 preferably executes one or more thesaurus database queries using one or more of the claim elements (i.e., synonym lists) entered by the user (block 412). Preferably, the thesaurus database query produces a group of suggested synonyms for each claim element. In this manner, the user may be given a separate list of suggested synonyms for each claim element. For example, if a claim element is defined by the user inputs as “internet, world wide web”, the suggested synonyms may include “network, www, WAN”. One or more of the user inputs may be used as inputs to the thesaurus database query. In one example, each of the user inputs is used in a separate thesaurus database query, and then duplicates (with respect to other query results for that claim element as well as the user input list for that claim element) are removed from the group of suggested synonyms. Alternatively, each query result from each user input may be kept separate. In this manner, the user may be given a separate list of suggested synonyms for each word entered (as opposed to each group of words representing a single claim element). In addition, the number of synonyms may be reduced to a predefined maximum number.

Once the server 104 determines the number of occurrences of each claim element for the top X (e.g., 25) prior art documents and looks up suggested synonyms, the server 104 transmits these results to the client 102 (block 414). In addition, the server 104 may echo back the user inputs (e.g., claim elements, critical date, docket number, etc.). The client 102 then displays this data (e.g., in the form of a web page as shown in FIG. 14a).

The user may then revise the search by modifying any of the user inputs (e.g., claim elements, critical date, specific document identifier lists, docket number, etc.) and pressing the search button 1412 (block 416). This process (blocks 408-416) continues until the user quits or presses the purchase button 1416. If the user presses the purchase button 1416, the server 104 receives a purchase request from the client 102 (block 418).

Turning to FIG. 5, once the purchase request is received from the client 102, the server 104 attempts to identify the user automatically (block 502). For example, the server may attempt to read cookie information previously stored on the client device 102. The cookie may store any type of user identification information such as a user name, an e-mail address, and/or a customer number. If the server 104 is unable to identify the user automatically, the server 104 preferably prompts the user for some user identification information (block 504). For example, the server 104 may send the client device 102 a login web page with an input box for the user's e-mail address and password. In addition, the login web page preferably includes a signup button the user may select to register as a new user. If the user presses the signup button (block 506), the server 104 preferably sends a signup web page 2100 (block 508).

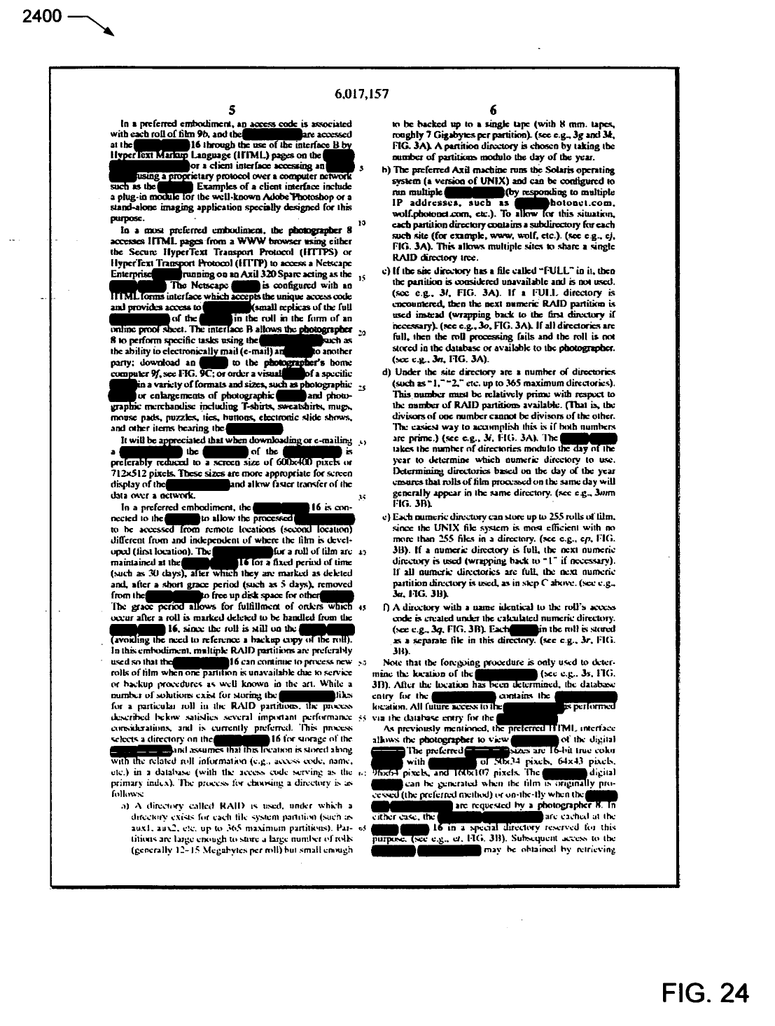

An example of a signup web page 2100 is illustrated in FIG. 21. In this example, the signup web page 2100 includes input boxes for login information 2102, company information 2104, and payment information 2106. Preferably, if the user enters a Patent and Trademark Office (PTO) registration number (block 510), the server 104 automatically fills in the company information 2104 and/or some of the payment information 2106 based on the registered patent attorney/agent database 116 (block 512). Similarly, the server 104 may automatically fill in some of the company information 2104 and/or some of the payment information 2106 based on a user's e-mail address. For example, the server 104 may determine that any new user from the “xyz.com” domain (e.g., john@xyz.com) belongs to a firm or corporation that is preapproved for invoice type billing thereby eliminating the need for credit card information and automatically filling in the company information 2104. Preferably, the client 102 sends the Patent and Trademark Office (PTO) registration number and/or the e-mail address as soon as that data is entered (e.g., on a “change” event).

The user may then modify the automatically entered data (e.g., change the mailing address) and/or enter missing data manually (e.g., e-mail address, password, credit card information) (block 514). During the user entry of data, the client 102 may automatically fill in some of the payment information 2106 based on company information entered by the user.

Once the user has successfully registered, or logged in with a previously registered e-mail address and password (blocks 516 and 518), the server 104 communicates with the credit card processing server 120 and sends the client device 102 a web page which includes the specific document identifiers purchased (block 520). Of course, other means of payment may be also be used. For example, the user may be sent an electronic and/or paper invoice.

In one example, the user may purchase unlimited searching for a matter. Preferably, the price of previous purchases (if any) associated with the same matter (e.g., docket number) are deducted from the price of an unlimited search for that same matter. For example, if the user purchased the top five documents for $100, and the price of unlimited searching is $225, then the new price for unlimited searching for that matter is $125. Similarly, if the price to reveal the top ten documents is normally $175, and the price for unlimited searching is $225, and the user already purchased one set of top ten documents for $175, the new price to purchase unlimited searching for that matter is only $50. In other words, the user is assured (in this example) of never spending more than some cap (e.g., $225) on a particular matter no matter how much searching he does and/or what order he makes his purchases in.

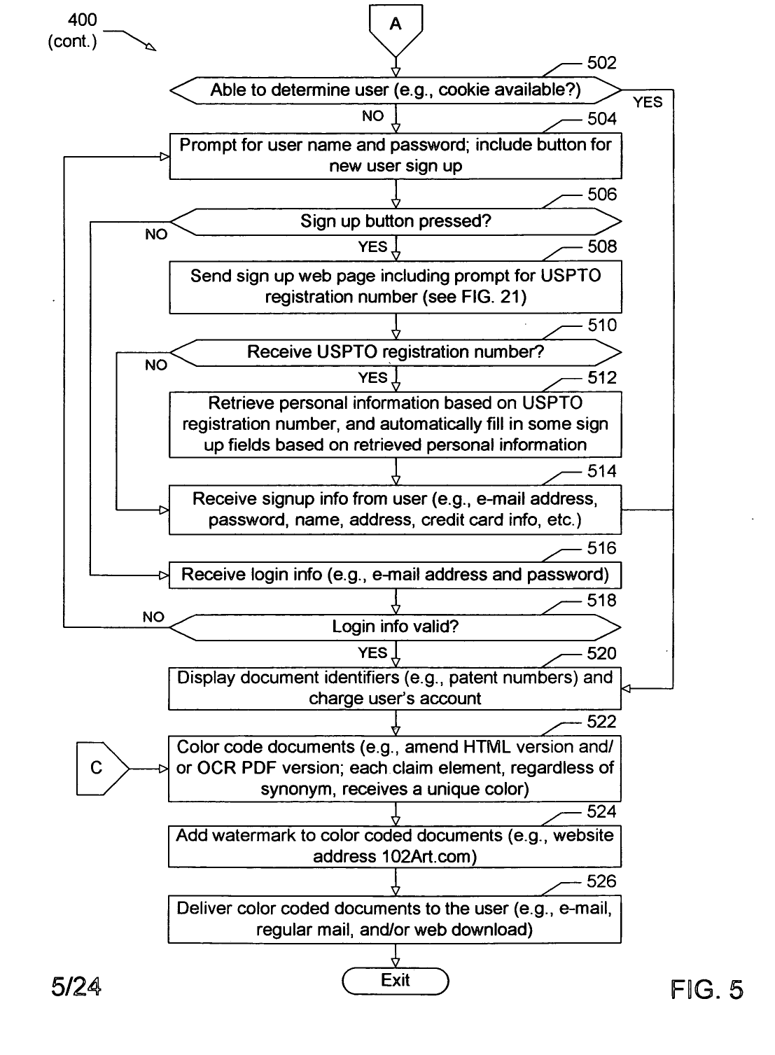

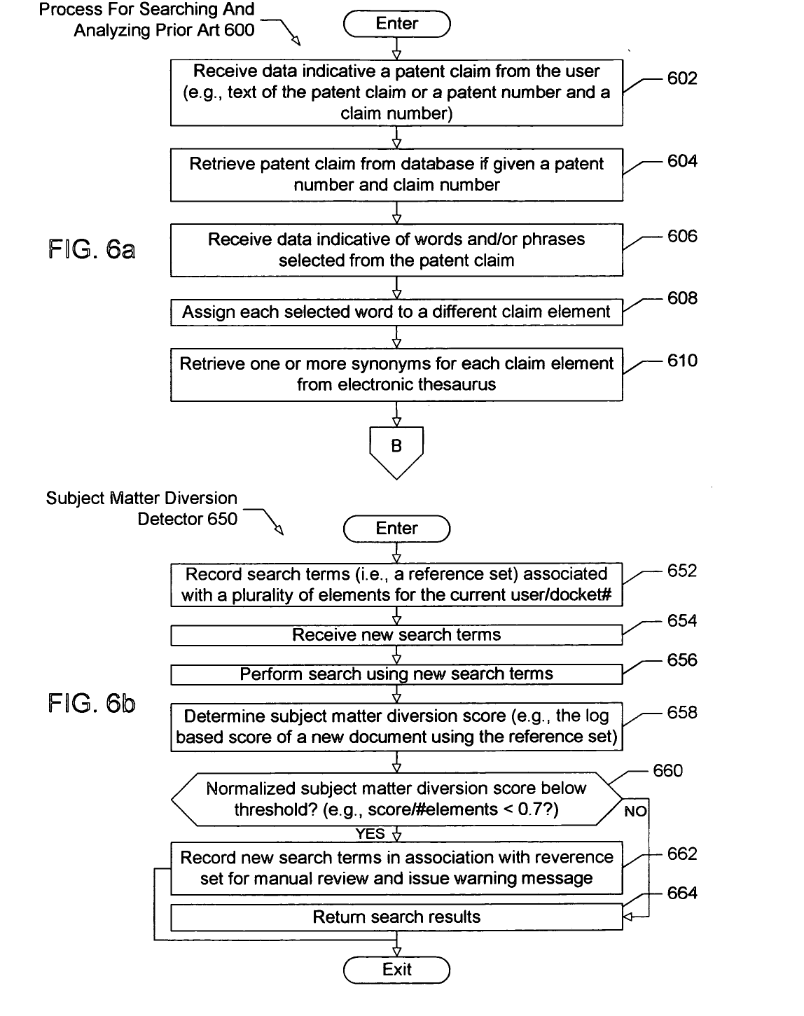

In order to prevent users from purchasing a search for one matter and then performing searches for additional matters under the same docket number (for a discounted search fee or for no additional search fee), the server 104 may employ a subject matter diversion process 650. A flowchart illustrating a subject matter diversion process 650 is illustrated in FIG. 6b. Generally, the subject matter diversion process 650 records the search terms (i.e., synonym lists) used by the user at one point in time (e.g., when a first purchase is made) and compares the recorded search terms to subsequent search terms and/or search results for the same docket number in order to determine if the user is attempting to perform a search for a new matter under the same docket number thereby avoiding additional search fees.

The subject matter diversion process 650 begins by recording a plurality of search terms (i.e., a reference set) associated with a plurality of elements for the current user and docket number (block 652). For example, the process 650 may store the reference set of search terms when a first purchase is made by a user for a particular docket number. Of course, other sets of search terms (or all sets of search terms) may also be stored. After the reference set of search terms is stored, the user enters another set of search terms and requests another search (block 654). The server 104 then performs the search using the new search terms (block 656). However, before returning the new search results to the user (in the case of unlimited searching) and/or before allowing the user to purchase those new documents (in the case of discounted searching), the server 104 checks for subject matter diversion by determining a subject matter diversion score for the new search (block 658).

In one example, the server 104 determines the subject matter diversion score by calculating the log based score (described above) of one or more of the new documents using the reference set of search terms. In another example, the server 104 determines the subject matter diversion score by comparing the original rank of one or more documents to the new rank of the same document(s). In yet another example, the server 104 determines the subject matter diversion score by comparing the log based score of an original search result document using the new search terms. In another example, the server 104 determines the subject matter diversion score by comparing the original search terms to the new search terms.

In any event, the score (or scores) are then compared to a threshold (block 660). The threshold may be a predetermined number and/or a percentage of another score, such as the log based score associated with one or more documents returned when the reference set of search terms was stored (e.g., when a first purchase is made). For example, the process 650 may determine the log based score of the new top five documents using the reference set of search terms. That log based score may then be divided by the number of nonempty elements in order to normalize the subject matter diversion score.

If a predetermined number of the subject matter diversion scores are below the threshold, the process 650 determines that a new subject is being searched despite the common docket number. For example, if the majority (e.g., 3 or more of 5) of these normalized scores is below the threshold (e.g., 0.7), the process 650 may determine that a new subject is being searched. If the process 650 determines that a new subject is being searched, the process 650 preferably stores the new search terms (block 662) to facilitate a subsequent manual check and review and/or issues a warning message (block 662) to the user (with or without returning the new search results to the user). If a predetermined number of the subject matter diversion scores are not below the threshold, the process 650 returns the new search results to the user (block 664).

After the user purchases a group of documents, the server 104 prepares color coded versions of those documents (block 522). Example pages 2500, 2600 of a color coded document in HTML format are illustrated in FIGS. 25-26. In this example, the color coded document is constructed by adding a header 2502 and color highlights 2504 to a preexisting HTML version of the document. The header 2502 includes the user's docket number 2506 and options 2508 for designating the document as blacklisted, graylisted, or whitelisted. In addition, the header 2502 includes color coded hyperlinks 2510 to the first occurrence of each element, the total number of occurrences 2512 of each element in the document, and a synonym list 2514 representing each element. If the user selects one of the color coded hyperlinks 2510, the document is scrolled to the first occurrence of that element. Similarly, if the user selects one of the color coded elements 2504, the document is scrolled to the next occurrence of that element (regardless of which synonym represents that element). This color coding and inner-document hyperlinking may be added to the preexisting HTML document by inserting the appropriate HTML tags in a well known manner. For example, a server side Perl script may perform a series of search and replaces operations on the preexisting HTML document.

In addition, the server 104 may prepare color coded versions of the purchased documents by retrieving page description format (PDF) versions of the purchased documents, performing an optical character recognition (OCR) process on the PDFs (if not previously performed and stored), and inserting color highlights over the PDF image in the location of the claim elements as defined by the words and/or phrases entered by the user in the claim input boxes 1406. Preferably, each word or phrase belonging to the same claim element is highlighted using the same color, while other groups of words and phrases belonging to other claim elements are highlighted using other colors. Preferably, the color coding scheme used by the chart output boxes 1410 is carried through to the color coding scheme used in the highlighted documents.

An example of a color coded PDF is illustrated in FIGS. 22-24. FIG. 22 shows an example of a U.S. patent cover page 2200. FIG. 23 shows an example of a U.S. patent drawings page 2300. FIG. 24 shows an example of a U.S. patent specification page 2400. As shown, any of these types of pages that contain search terms may be color coded. Preferably, all of the pages of the document are delivered to the user together as one searchable PDF file. Of course, document formats other than PDF may be used. For example, tagged image file format (TIFF) documents may be used.

In addition, the server 104 may add a watermark to one or more pages of the color coded documents (block 524). For example, each page may be modified to include a watermark of the server's website address (e.g., 102ART.com). Other modifications to the color coded document may also be made. For example, indicators for high concentrations of claim elements (as measured by physical distance or word count distance) may be added to the color coded documents. Preferably, word count distances are calculated in a known manner using a text version of the document. Similarly, physical distances may be measured in pixels using a graphical (e.g., PDF) version of the document.

Still further, a cover page showing the search grid may be included with the color coded documents. The cover page search grid preferably includes each row of claim input boxes 1406 (including the user's inputs) and the associated chart output boxes 1410 (including the graphical results of the search and the specific document identifiers) along with the user's docket number and critical date.

Once the color coded documents are prepared, the color coded documents are delivered to the user (block 526). Preferably, the color coded documents are delivered electronically via e-mail and/or website download. Alternatively, a hard copy of the color coded documents may be mailed to the user.

A flowchart of another example process 600 for analyzing prior art is illustrated in FIG. 6a. Preferably, the process 600 is embodied in one or more software programs which is stored in one or more memories and executed by one or more processors. Although the process 600 is described with reference to the flowchart illustrated in FIG. 6a, a person of ordinary skill in the art will readily appreciate that many other methods of performing the acts associated with process 600 may be used. For example, the order of many of the steps may be changed. In addition, many of the steps described are optional.

Generally, the process 600 receives data indicative of a patent claim, such as the text of the patent claim or a patent number and a claim number, from the user. The user and/or the server 104 may then select words and/or phrases form the patent claim to be used as the claim element inputs for the search process 400 described above.

The process 600 begins when the website server 104 receives data indicative of a patent claim from a client device 102 (block 602). For example, a user may transmit the text of one or more patent claims to the server 104. Alternatively, the user may transmit a patent number and optionally one or more claim numbers associated with the patent number to the server 104. If the user transmits a patent number, the server 104 retrieves the text of one or more claims of that patent from the database 110 (block 604). For example, if the user transmitted U.S. Pat. No. 6,000,000 and claim number 1 (which may be a default value), the server 104 would retrieve the text for claim 1 of U.S. Pat. No. 6,000,000.

Next, the user selects one or more words or phrases from the text of the patent claim and transmits data indicative of these selections to the server 104 (block 606). Each of these selections is assigned to a claim element group (block 608). In one example, the user determines which claim element group is associated with each selection. For example, the user may drag-and-drop the selections into claim input boxes 1406. In another example, the client device 102 and/or the server 104 determines which claim element group is associated with each selection. For example, the colon, semicolons, and period markers of typical claim text may be used to designate claim element areas, and selections from the same area may be grouped together. In addition, the server 104 may suggest or automatically supply one or more synonyms for one or more of the words or phrases (block 610).

Once the claim element groups are defined, the process 600 preferably continues to block 406 of FIG. 4 and operates as described above with reference to FIG. 4 and FIG. 5. In this manner, the user may modify the search, purchase color code search results, etc.

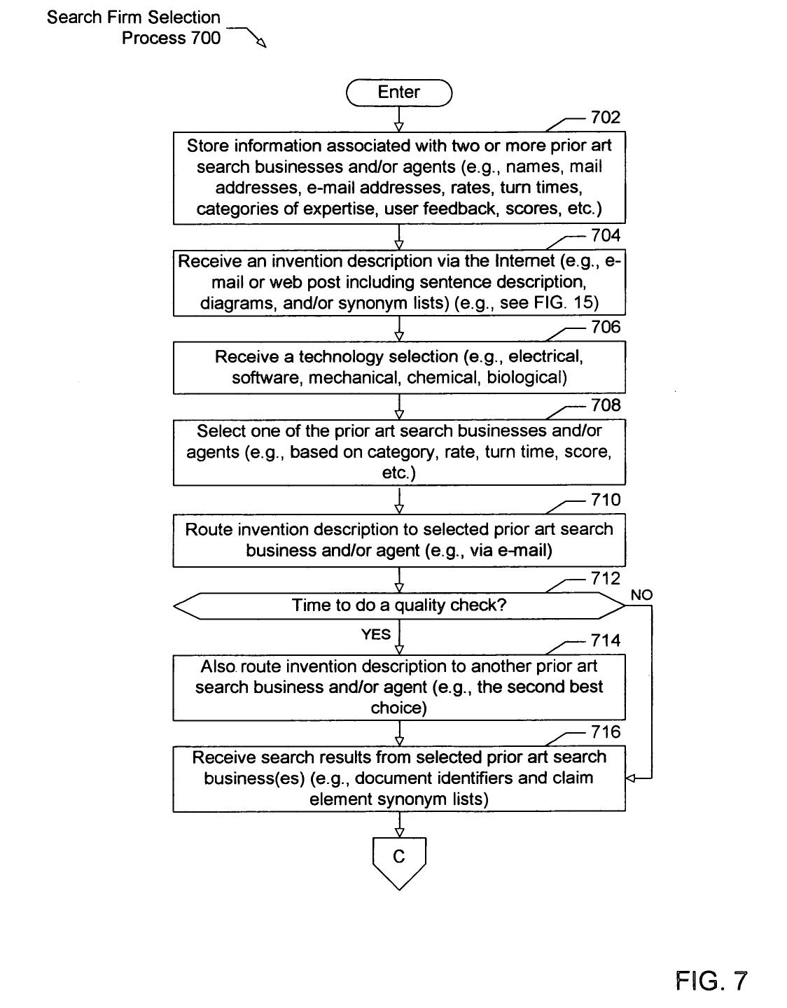

A flowchart of an example process 700 for selecting a prior art search firm is illustrated in FIG. 7. Preferably, the process 700 is embodied in one or more software programs which is stored in one or more memories and executed by one or more processors. Although the process 700 is described with reference to the flowchart illustrated in FIG. 7, a person of ordinary skill in the art will readily appreciate that many other methods of performing the acts associated with process 700 may be used. For example, the order of many of the steps may be changed. In addition, many of the steps described are optional.

Generally, the process 700 receives an invention description letter via the Internet and routes the invention description to a professional searcher based on technology selection information (e.g., mechanical, electrical, etc.) included with the search letter and/or based on predefined criteria (e.g., rates, turn times, quality scores, etc.) associated with the professional searcher. Periodically, the process 700 also routes the invention description to a second professional searcher in order to perform a quality check. When a quality check is performed, the user is asked to select which of two “redundant” searches is preferred, and the user's selection is used to adjust scores associated with the professional searchers.

The process 700 begins when the website server 104 receives information associated with two or more prior art searching businesses and/or searching agents (block 702). For example, the information associated with the prior art searching businesses/agents may include names, physical mail addresses, e-mail addresses, rates, turn times, categories of expertise, user feedback data, scores related to user feedback data, etc. Subsequently, a registered user may submit an invention description letter to the server 104 (block 704).

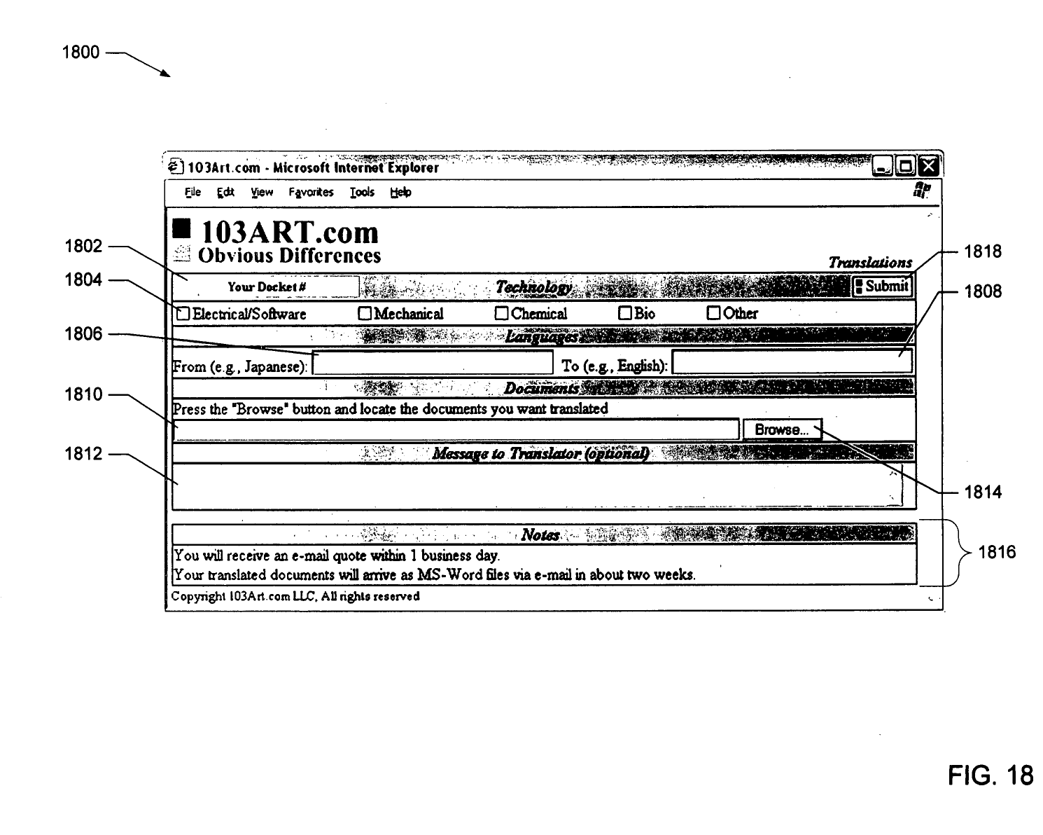

An example of a web page 1500 which may be used to collect the invention description letter is illustrated in FIG. 15. In this example, the search letter web page 1500 includes a docket number input box 1502, a plurality of technology type check boxes 1504, a search letter input box 1506, and an attachment input box 1508. The user may browse for one or more attachments by pressing a browse button 1510. The user enters/modifies the data in one of more of the input boxes on the web page 1500 and sends the data to the web server 104 by pressing a submit button 1512.

The user may enter a docket number in the docket number input box 1502 in order to identify a search. Preferably, the server 104 stores a unique identifier associated with the user (e.g., customer number or e-mail address) and the docket number in association with at least the most recent version of the user's search letter in the user database 112. In this manner, correspondence between the server 104 and the user may be identified, and previously conducted searches may be retrieved and modified.

The user may check one or more of the technology type check boxes 1504 in order to characterize the subject matter of a search letter. Examples of technology types include electrical, software, mechanical, chemical, and biological. This information may be used to route the search letter to an individual and/or business associated with the selected area. For example, the server 104 may route mechanical search letters to a first prior art searching business and chemical search letters to a second prior art searching business.

The user may enter a plurality of sentences into the search letter input box 1506 in order to describe the subject matter of the search and/or special instructions regarding the search. In addition, the user may enter a path to one or more attachments in the attachment input box 1508 in order to describe the subject matter of the search. For example, the user may attach an invention disclosure document, diagrams, etc. These attachments are preferably transmitted to the server 104 along with the other input information when the user presses the submit button 1512.

Returning to FIG. 7, once the server 104 receives an invention description (block 704) and/or a technology selection (block 706), one or more prior art searching businesses/agents are selected (block 708). Preferably, a prior art searching business/agent is selected by the server 104 based on one or more predefined criteria. The predefined criteria may include information associated with the prior art searching business in the subcontractor database 118 such as rates, quotes, historical turn times, promised turn times, categories of expertise, user feedback data, scores related to user feedback data, etc. For example, the server 104 may decide to route a mechanical search letter to a search firm with expertise in the mechanical arts that currently has the highest user feedback score.

In another example, a web page may be provided for the prior art searchers which includes an area for each searcher to enter a current turn time promise, a price quote, and select one or more technology areas he specializes in. The web page may show the prior art searcher his feedback score, his average turn time promise, his average actual turn time, his current turn time promise, his current price quote, and/or other data. Each of these variables may then be used to determine an overall score and rank. For example, a searcher's overall score may be determined as: (FeedbackPoints)*A+(AverageTurnTimePromise/AverageTurnTime)*B+(1/CurrentTurnTimePromise)*C+(1/PriceQuote)*D, where A, B, C, D are constants used to weight each term. A searcher's rank may then be determined by comparing his score to all of the other searcher's scores (e.g., highest overall score is ranked first, second highest overall score is ranked second, etc.).

The searcher may then adjust his current turn time promise and/or current price quote to see how these changes affect his current rank. A searcher ranked number one will receive the next search job(s) (in his technology area), a searcher ranked number two will receive the search job(s) after that (in his technology area) etc. The web page may also allow the searcher to enter a number of search jobs he is willing to accept each day (e.g., 0-3 in 0.1 increments). In this manner, a searcher ranked number one will not receive all of the search jobs.

Once a prior art search business/agent is selected, data indicative of the invention description letter received by the server 104 is routed to the prior art search business computer 106 associated with the selected prior art search business/agent (block 710). Information sent to the prior art search business computer 106 may include data collected from the user by the docket number input box 1502, the technology type check boxes 1504, the search letter input box 1506, the attachment input box 1508, and/or other input boxes.

Periodically, the server 104 may perform a quality check in order to adjust the user feedback scores associated with one or more prior art search businesses/agents. If the server 104 determines that a quality check is to be performed (block 712), the server 104 selects a second prior art searching business/agent to perform the same prior art search and routes the data indicative of the invention description letter to a second prior art search business computer 106 associated with the second prior art search business/agent (block 714).

After each prior art searching business/agent performs the requested prior art search, each prior art searching business/agent preferably transmits data indicative of the search results to the website server 104 and/or the client 102 (block 716). In one example, the data indicative of the search results includes the docket number associated with the search request and a plurality of claim element groups (i.e., a list of words and/or phrases for each claim element). Subsequently, the server 104 may execute one or more database queries using the received claim element groups and critical date associated with the received docket number. The results may then be used to prepare and deliver color coded versions of those documents to the user (blocks 522-526). Alternatively, the prior art searching business/agent may prepare and/or send the color coded documents to the user.

In another example, the data indicative of the search results also includes a plurality of document identifiers (e.g., whitelisted patent numbers). By sending a plurality of document identifiers and claim element groups (as opposed to just the claim element groups), the prior art searching business/agent is able to select and communicate prior art documents associated with claim element groups as being in the top X results even if the automatic selection process used by the server (e.g., the process 400) would not consider those prior art documents to be in the top X results. In any event, if the user is sent search results from more than one prior art searching business/agent, the user may be asked to respond to the server 104 with an indication as to which of search results the user considers superior.

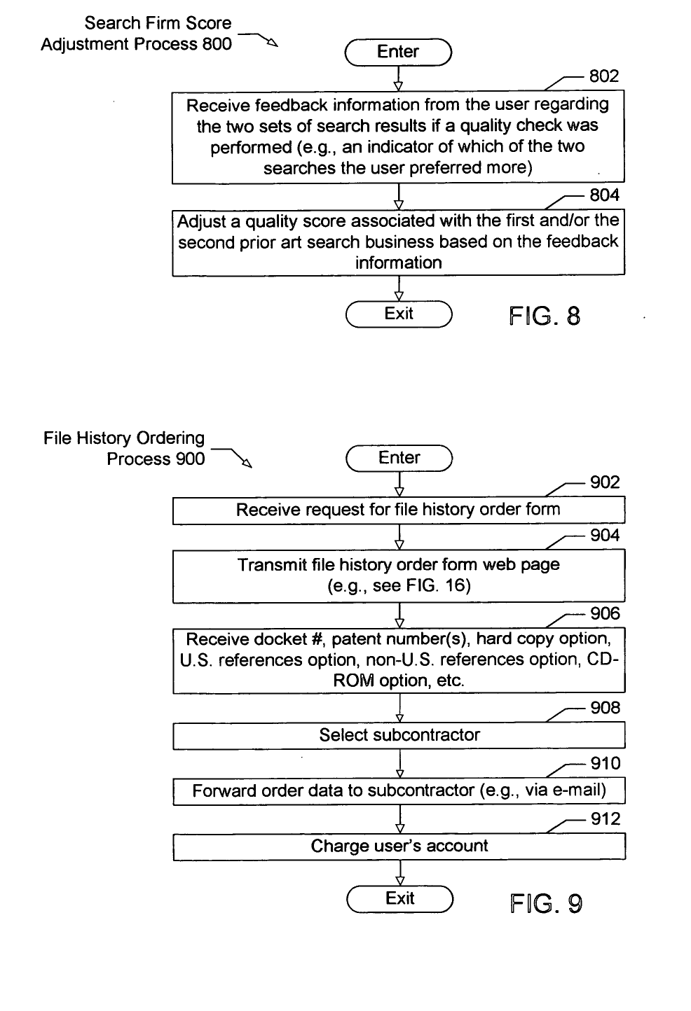

A flowchart of an example process 800 for adjusting a score associated with a prior art searching business based on user feedback is illustrated in FIG. 8. Preferably, the process 800 is embodied in one or more software programs which is stored in one or more memories and executed by one or more processors. Although the process 800 is described with reference to the flowchart illustrated in FIG. 8, a person of ordinary skill in the art will readily appreciate that many other methods of performing the acts associated with process 800 may be used. For example, the order of many of the steps may be changed. In addition, many of the steps described are optional.

The process 800 begins when the website server 104 receives feedback information from a user regarding search results (block 802). Preferably the feedback information is an indication of which of two sets of search results is preferred by the user. However, any number of sets of search results may be used. For example the user may provide feedback regarding a single set of search results (e.g., good, average, poor) or three sets of search results (e.g., first, second, third). The feedback information is then used to adjust a score associated with one or more prior art searching businesses (block 804). For example, if the user is provided with search result set A from searcher A and search result set B from searcher B, and the user indicates that search result set B is preferred over search result set A, then prior art searcher A may lose one point while prior art searcher B gains one point.

The website server may provide services other than prior art searching such ordering file histories, formal drawings, translations, patents, and watchdogs. Each of these services is described below with reference to corresponding flowcharts and screenshots.

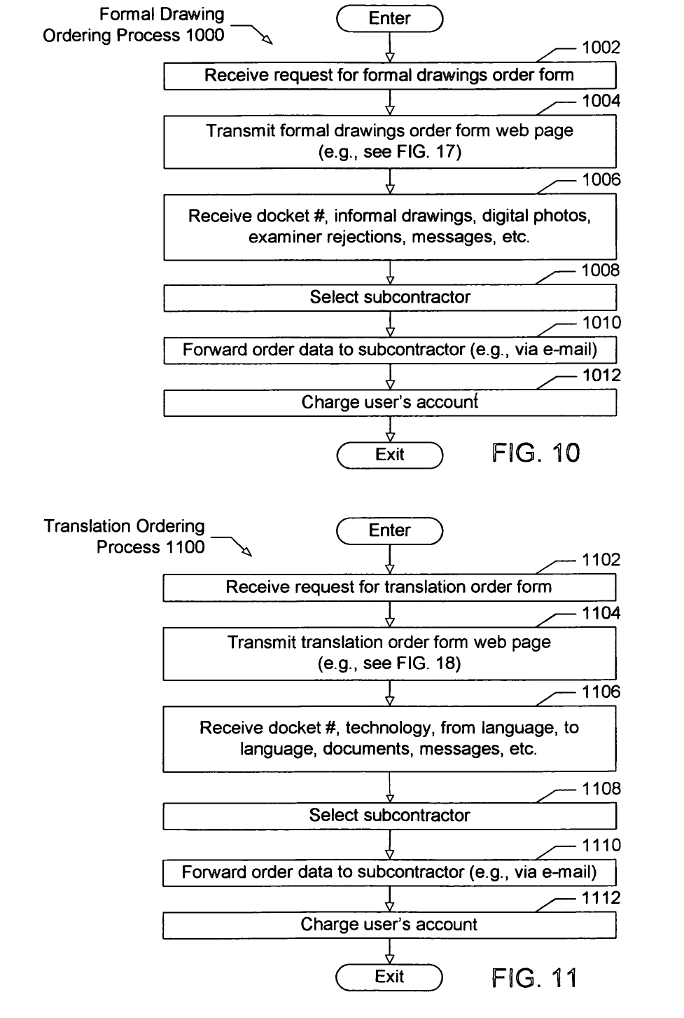

A flowchart of an example process 900 for ordering one or more file histories is illustrated in FIG. 9. Preferably, the process 900 is embodied in one or more software programs which is stored in one or more memories and executed by one or more processors. Although the process 900 is described with reference to the flowchart illustrated in FIG. 9, a person of ordinary skill in the art will readily appreciate that many other methods of performing the acts associated with process 900 may be used. For example, the order of many of the steps may be changed. In addition, many of the steps described are optional.

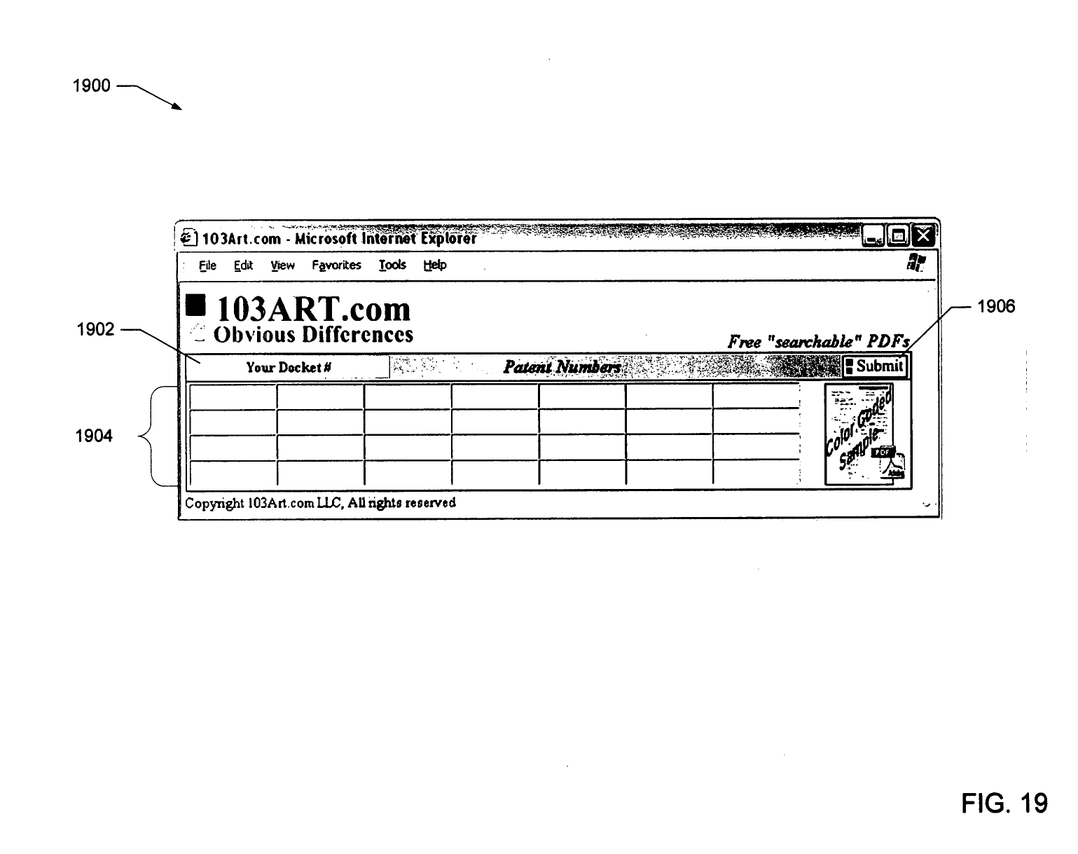

The process 900 begins when the website server 104 receives a request for a file history order form (block 902). In response, the server 104 preferably provides a file history order form web page (block 904). An example of a file history order form web page 1600 is illustrated in FIG. 16. In this example, the web page 1600 includes a docket number input box 1602, a plurality of patent number input boxes 1604, and a plurality of check box options 1606. Once the user completes the file history order form web page 1600, and presses a submit button 1608, data indicative of the user inputs is sent to the server 104 (block 906). The server 104 then selects a subcontractor from one or more predefined subcontractors based on one or more criteria associated with the user's order data and/or the subcontractor (block 908). The server 104 then forwards the user's order data to a computer associated with the selected subcontractor (block 910) and charges the user's account (block 912).

Preferably, the subcontractor is paid by a business associated with the website server (e.g., 102ART.com), and the subcontractor packages the file history in a way that the file history appears to come from the business associated with the website server and not the subcontractor's business (e.g., File Histories, LLC). In such an instance, the subcontractor preferably sends the file history directly to the user. Alternatively, the subcontractor may send the file history to the business associated with the website server (e.g., 102ART.com). In such an instance, the business associated with the website server could then perform quality assurance checks and/or repackage the file history.

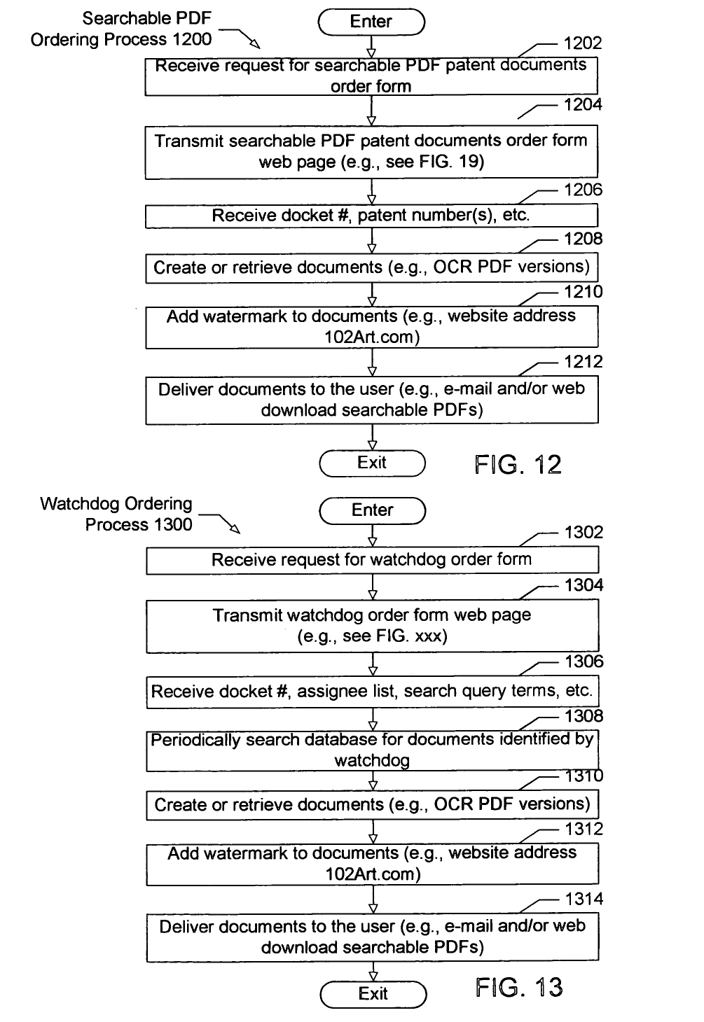

A flowchart of an example process 1000 for ordering formal drawings is illustrated in FIG. 10. Preferably, the process 1000 is embodied in one or more software programs which is stored in one or more memories and executed by one or more processors. Although the process 1000 is described with reference to the flowchart illustrated in FIG. 10, a person of ordinary skill in the art will readily appreciate that many other methods of performing the acts associated with process 1000 may be used. For example, the order of many of the steps may be changed. In addition, many of the steps described are optional.

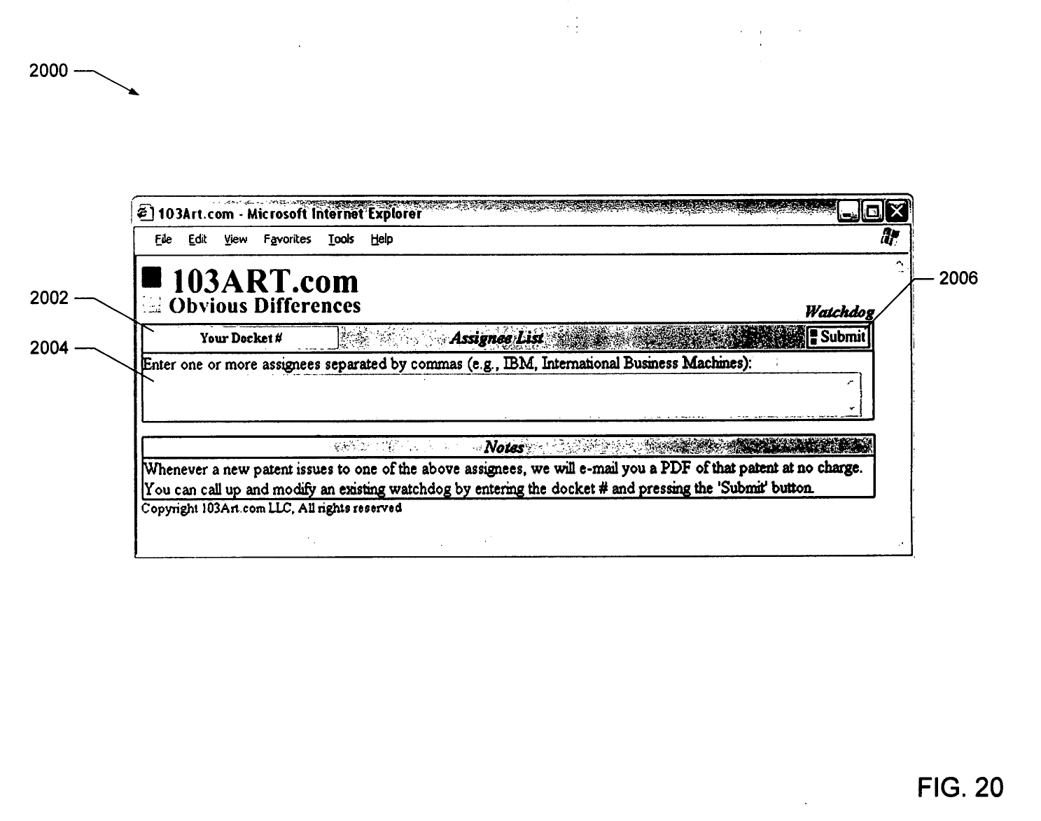

The process 1000 begins when the website server 104 receives a request for a formal drawing order form (block 1002). In response, the server 104 preferably provides a formal drawing order form web page (block 1004). An example of a formal drawing order form web page 1700 is illustrated in FIG. 17. In this example, the web page 1700 includes a docket number input box 1702, an attachment input box 1704, and a message to the illustrator input box 1706. The user may browse for one or more attachments by pressing a browse button 1708. The web page 1700 may also include a notes section 1710 that includes hyperlinks 1712 to sample drawings in different price ranges.

Once the user completes the formal drawing order form web page 1700, and presses a submit button 1714, data indicative of the user inputs is sent to the server 104 (block 1006). The server 104 then selects a subcontractor from one or more predefined subcontractors based on one or more criteria associated with the user's order data and/or the subcontractor (block 1008). The server 104 then forwards the user's order data to a computer associated with the selected subcontractor (block 1010) and charges the user's account (block 1012).

Again, the subcontractor is preferably paid by a business associated with the website server (e.g., 102ART.com), and the subcontractor packages the formal drawings in a way that the formal drawings appear to come from the business associated with the website server and not the subcontractor's business (e.g., Formal Drawings, LLC). In such an instance, the subcontractor preferably sends the formal drawings directly to the user. Alternatively, the subcontractor may send the formal drawings to the business associated with the website server (e.g., 102ART.com). In such an instance, the business associated with the website server could then perform quality assurance checks and/or repackage the formal drawings.

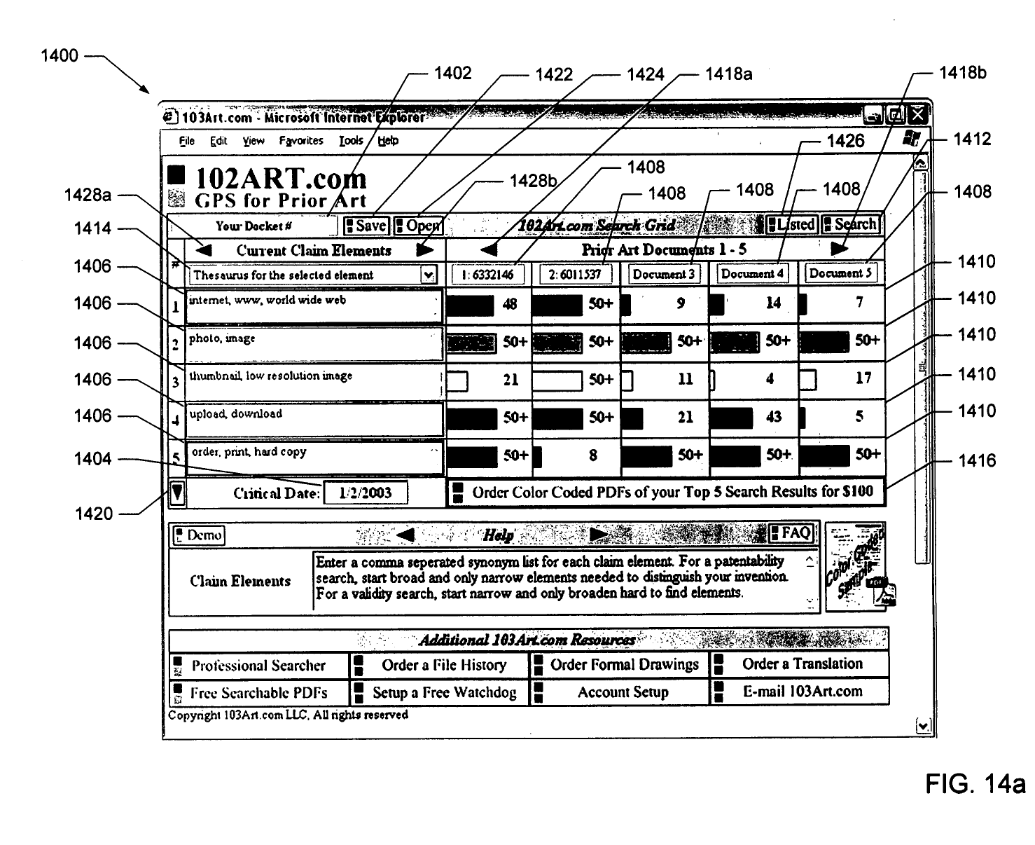

A flowchart of an example process 1100 for ordering translations is illustrated in FIG. 11. Preferably, the process 1100 is embodied in one or more software programs which is stored in one or more memories and executed by one or more processors. Although the process 1100 is described with reference to the flowchart illustrated in FIG. 11, a person of ordinary skill in the art will readily appreciate that many other methods of performing the acts associated with process 1100 may be used. For example, the order of many of the steps may be changed. In addition, many of the steps described are optional.

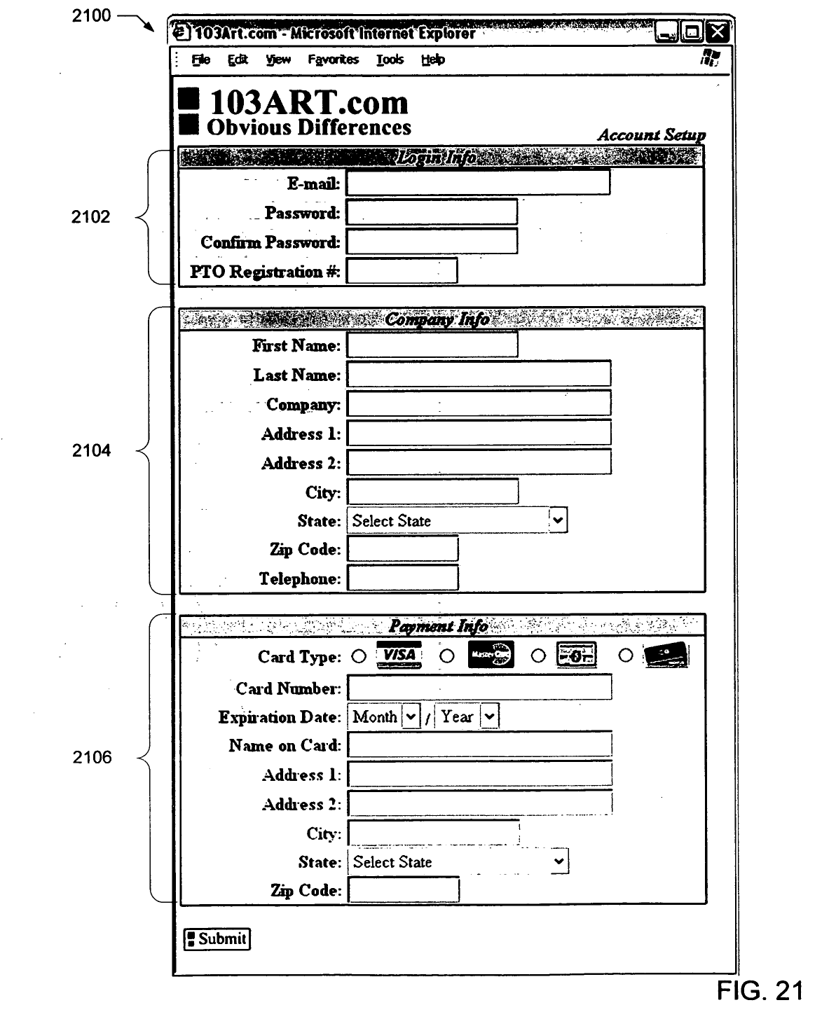

The process 1100 begins when the website server 104 receives a request for a translations order form (block 1102). In response, the server 104 preferably provides a translations order form web page (block 1104). An example of a translations order form web page 1800 is illustrated in FIG. 18. In this example, the web page 1800 includes a docket number input box 1802, a plurality of technology type check boxes 1804, a “from” language input box 1806, a “to” language input box 1808, an attachment input box 1810, and a message to the translator input box 1812. The user may browse for one or more attachments by pressing a browse button 1814. The web page 1800 may also include a notes section 1816.

Once the user completes the translations order form web page 1800, and presses a submit button 1818, data indicative of the user inputs is sent to the server 104 (block 1106). The server 104 then selects a subcontractor from one or more predefined subcontractors based on one or more criteria associated with the user's order data and/or the subcontractor (block 1108). The server 104 then forwards the user's order data to a computer associated with the selected subcontractor (block 1110) and charges the user's account (block 1112).

Again, the subcontractor is preferably paid by a business associated with the website server (e.g., 102ART.com), and the subcontractor packages the translations in a way that the translations appear to come from the business associated with the website server and not the subcontractor's business (e.g., Translations, LLC). In such an instance, the subcontractor preferably sends the translations directly to the user. Alternatively, the subcontractor may send the translations to the business associated with the website server (e.g., 102ART.com). In such an instance, the business associated with the website server could then perform quality assurance checks and/or repackage the translations.

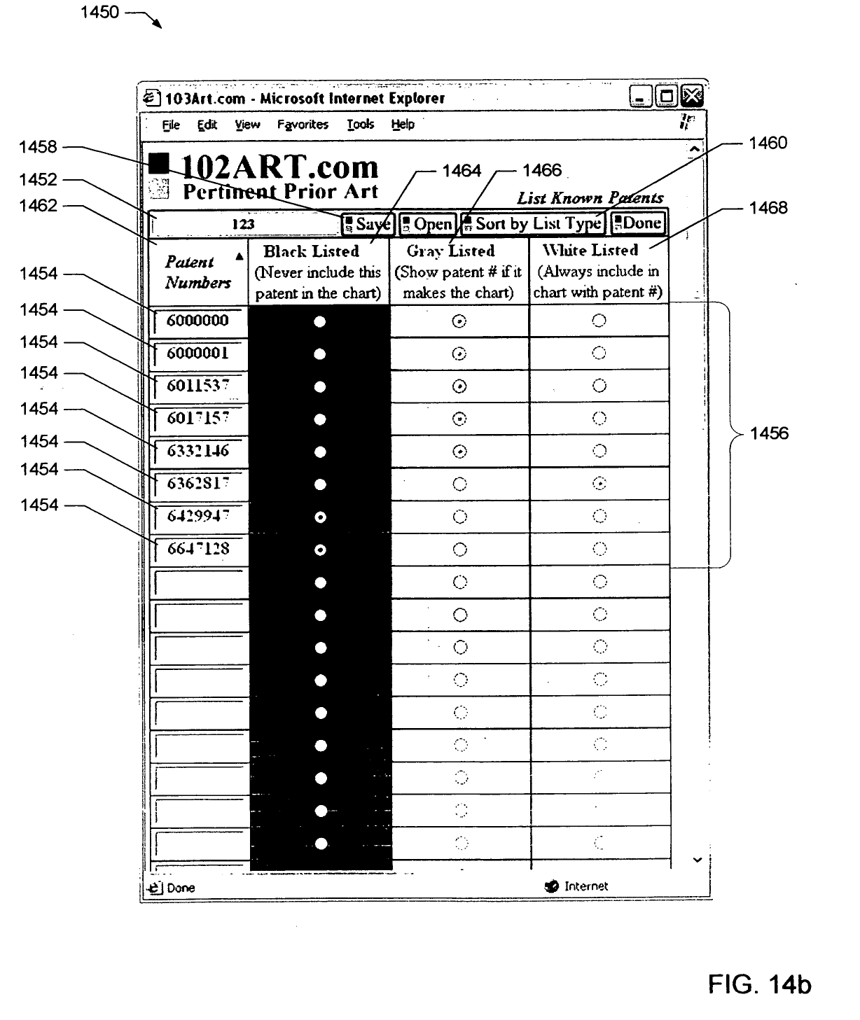

A flowchart of an example process 1200 for ordering searchable PDFs of patent documents by specific document number is illustrated in FIG. 12. Preferably, the process 1200 is embodied in one or more software programs which is stored in one or more memories and executed by one or more processors. Although the process 1200 is described with reference to the flowchart illustrated in FIG. 12, a person of ordinary skill in the art will readily appreciate that many other methods of performing the acts associated with process 1200 may be used. For example, the order of many of the steps may be changed. In addition, many of the steps described are optional.

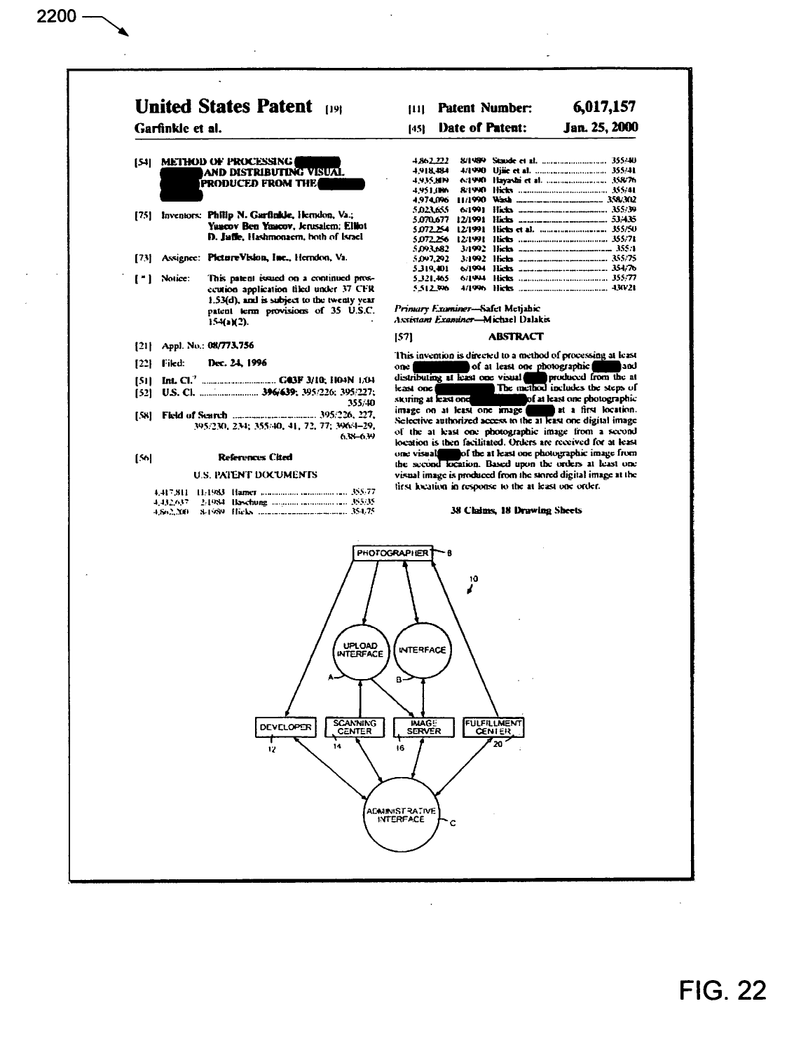

The process 1200 begins when the website server 104 receives a request for a searchable PDF patent order form (block 1202). In response, the server 104 preferably provides a searchable PDF patent order form web page (block 1204). An example of a searchable PDF patent order form web page 1900 is illustrated in FIG. 19. In this example, the web page 1900 includes a docket number input box 1902 and a plurality of patent number input boxes 1904. Once the user completes the searchable PDF patent order form web page 1900, and presses a submit button 1906, data indicative of the user inputs is sent to the server 104 (block 1206).

The server 104 then creates and/or retrieves the requested documents (block 1208). For example, the server may create the requested documents by retrieving TIFF images of the requested patents, performing an OCR process on the TIFF images, and generating a searchable PDF. Alternatively, the server 104 or another computing device may generate the searchable PDF prior to the user's request for the document. In such an instance, the server 104 may simply retrieve the previously prepared searchable PDF. In addition, the server 104 may add a watermark to one or more of the searchable PDF pages (block 1210). For example, the watermark may include a website address associated with the server 104.

The searchable PDF patents are then delivered to the user (block 1212). Preferably, the searchable PDF patents are delivered electronically via e-mail and/or website download. Alternatively, a hard copy of the PDF patents may be mailed to the user.

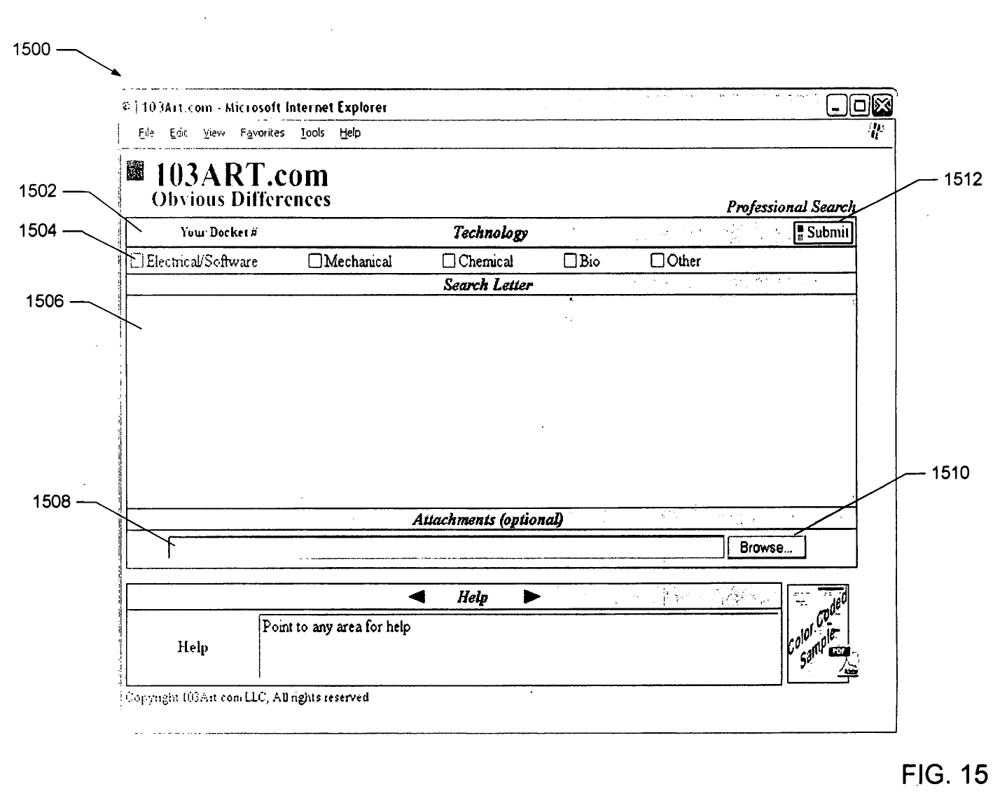

A flowchart of an example process 1300 for setting up a patent watchdog is illustrated in FIG. 13. Preferably, the process 1300 is embodied in one or more software programs which is stored in one or more memories and executed by one or more processors. Although the process 1300 is described with reference to the flowchart illustrated in FIG. 13, a person of ordinary skill in the art will readily appreciate that many other methods of performing the acts associated with process 1300 may be used. For example, the order of many of the steps may be changed. In addition, many of the steps described are optional.

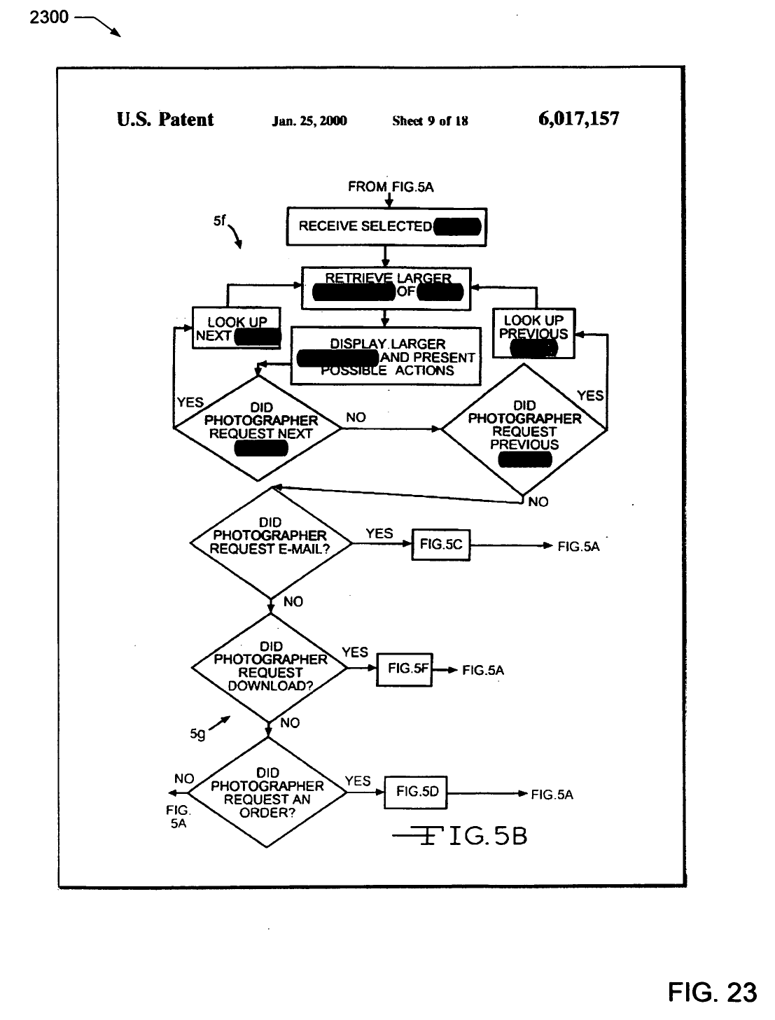

The process 1300 begins when the website server 104 receives a request for a watchdog order form (block 1302). In response, the server 104 preferably provides a watchdog order form web page (block 1304). An example of a watchdog order form web page 2000 is illustrated in FIG. 20. In this example, the web page 2000 includes a docket number input box 2002 and an assignee input box 2004. Once the user completes the watchdog order form web page 2000, and presses a submit button 2006, data indicative of the user inputs is sent to the server 104 (block 1306).

The server 104 periodically searches the prior art database 110 for documents associated with the assignee list (or other search terms) (block 1308). For example, the server 104 may search all patents issued and published each week for patents or publications assigned to entities identified by the user. In addition, the server 104 may lookup alternative spellings for assignees (e.g., IBM=International Business Machines).

The server 104 then creates and/or retrieves the requested documents (block 1310). For example, the server 104 may create the requested documents by retrieving TIFF images of the requested patents, performing an OCR process on the TIFF images, and generating a searchable PDF. Alternatively, the server 104 or another computing device may generate the searchable PDF ahead of time. In such an instance, the server 104 may simply retrieve the previously prepared searchable PDF. In addition, the server 104 may add a watermark to one or more of the searchable PDF pages (block 1312). For example, the watermark may include a website address associated with the server 104. Alternatively, or in addition, the server 104 may use HTML versions of the requested documents.

The searchable PDF patents and/or web pages are then delivered to the user (block 1314). Preferably, the documents are delivered electronically via e-mail and/or website download. Alternatively, a hard copy of the documents may be mailed to the user.

During the display of any of the above web pages, an advertisement may be displayed. Preferably, the client 102 and/or the server 104 determine if the user is associated with a law firm or a corporation by comparing the cookie or other login information of the user to a database. One advertisement may be presented for law firm clients (e.g., time keeping software), and another advertisement may be presented for corporate clients (e.g., a law firm logo/link). Similarly, certain advertisements may be set up to display to a specific law firm, a specific corporation (e.g., users who work at IBM), and/or a specific user (e.g., John Doe).

In summary, persons of ordinary skill in the art will readily appreciate that methods and apparatus for searching and analyzing prior art have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method of searching for prior art, the method comprising:
receiving a first synonym list from a user, the first synonym list including a first text string and a second text string;
receiving a second synonym list from the user, the second synonym list including a third text string and a fourth text string;
executing a database query based on the first synonym list and the second synonym list to produce a query result, the query result identifying a first document and a second document;
adding a number of occurrences of the first text string in the first document and a number of occurrences of the second text string in the first document to contribute to a first sum;
adding a number of occurrences of the third text string in the first document and a number of occurrences of the fourth text string in the first document to contribute to a second sum;
adding a number of occurrences of the first text string in the second document and a number of occurrences of the second text string in the second document to contribute to a third sum;
adding a number of occurrences of the third text string in the second document and a number of occurrences of the fourth text string in the second document to contribute to a fourth sum;
transmitting data indicative of a chart based on the first sum, the second sum, the third sum, and the fourth sum;
highlighting at least one instance of the first text string and at least one instance of the second text string in the first document using a first color and highlighting at least one instance of the third text string and at least one instance of the fourth text string in the first document using a second color to create a first highlighted document;
highlighting at least one instance of the first text string and at least one instance of the second text string in the second document using the first color and highlighting at least one instance of the third text string and at least one instance of the fourth text string in the second document using the second color to create a second highlighted document; and
delivering the first highlighted document and the second highlighted document to the user.

2. A method as defined in claim 1, further comprising:
ranking the first document higher than the second document if
(i) the first sum is non-zero;
(ii) the second sum is non-zero; and
(iii) at least one of the third sum and the fourth sum is zero.

3. A method as defined in claim 1, further comprising:
determining a first score associated with the first document, the first score being based on a fifth sum, the fifth sum being based on a first logarithm and a second logarithm, the first logarithm being based on the first sum, the second logarithm being based on the second sum;
determining a second score associated with the second document, the second score being based on a sixth sum, the sixth sum being based on a third logarithm and a fourth logarithm, the third logarithm being based on the third sum, the fourth logarithm being based on the fourth sum; and
ranking the first document relative to the second document based on a comparison of the first score and the second score.

4. A method as defined in claim 3, wherein ranking the first document relative to the second document based on the comparison of the first score and the second score comprises ranking the first document relative to the second document based on a comparison of the first score and the second score if a first number of zero count elements associated with the first document is equal to a second number of zero count elements associated with the second document.

5. A method as defined in claim 1, wherein the first document comprises a patent and the second document comprises a patent, the method further comprising:
hiding a first patent number associated with the first document from the user;
hiding a second patent number associated with the second document from the user; and
revealing the first patent number and the second patent number to the user in response to receiving a purchase command from the user.

6. A method as defined in claim 1, wherein the first document comprises a patent and the second document comprises a patent, the method further comprising:
hiding a first patent number associated with the first document from the user;
hiding a second patent number associated with the second document from the user; and
revealing the first patent number and the second patent number to the user in response to receiving the first patent number and the second patent number from the user.

7. A method as defined in claim 1, further comprising:
receiving a patent number from the user;
retrieving a third document based on the patent number;
adding a number of occurrences of the first text string in the third document and a number of occurrences of the second text string in the third document to contribute to a fifth sum; and
adding a number of occurrences of the third text string in the third document and a number of occurrences of the fourth text string in the third document to contribute to a sixth sum, wherein transmitting data indicative of the chart includes transmitting data based on the fifth sum and the sixth sum.

8. A method as defined in claim 7, wherein the third document is associated with a rank that would not be included in the chart, but for receiving the patent number associated with the third document from the user.

9. A method as defined in claim 7, further comprising:
highlighting at least one of the first text string and the second text string in the third document using the first color and highlighting at least one of the third text string and the fourth text string in the third document using the second color to create a third highlighted document; and
delivering the third highlighted document to the user.

10. A method as defined in claim 1, further comprising receiving a patent number, wherein the query result excludes a patent document because the patent document is associated with the patent number.

11. A method as defined in claim 1, further comprising suggesting a synonym to the user based on an electronic thesaurus.

12. A method as defined in claim 11, further comprising:
retrieving a first plurality of synonyms associated with the first text string;
retrieving a second plurality of synonyms associated with the second text string;
retrieving a third plurality of synonyms associated with the third text string;
retrieving a fourth plurality of synonyms associated with the fourth text string;
determining a first subset of synonyms based on the first plurality of synonyms and the second plurality of synonyms, wherein a first member of the first subset is selected over a first non-selected synonym because the first member is in the first plurality of synonyms and the second plurality of synonyms, and the first non-selected synonym is not in the second plurality of synonyms;
determining a second subset of synonyms based on the third plurality of synonyms and the fourth plurality of synonyms, wherein a second member of the second subset is selected over a second non-selected synonym because the second member is in the third plurality of synonyms and the fourth plurality of synonyms, and the second non-selected synonym is not in the fourth plurality of synonyms; and
causing at least a portion of the first subset of synonyms and at least a portion of the second subset of synonyms to be displayed to a prior art searcher.

13. A method as defined in claim 1, wherein the first synonym list and the second synonym list are in a first language, and the first synonym list and the second synonym list are translated to a second language prior to executing the database query.

14. A method as defined in claim 13, wherein the second language is determined by comparing content of the first document to a plurality of words in the second language.

15. A method as defined in claim 1, wherein delivering the first highlighted document and the second highlighted document to the user comprises transmitting the first highlighted document and the second highlighted document to the user via the Internet.

16. A method as defined in claim 15, wherein the first highlighted document includes a cover page, the cover page including a graphical representation of the first sum and the second sum.

17. A method as defined in claim 16, wherein the first highlighted document and the cover page are part of the same PDF file.

18. A method as defined in claim 1, wherein transmitting the data indicative of the chart comprises transmitting data indicative of at least one of a numerical chart and a graphical chart.

19. A method as defined in claim 1, wherein transmitting the data indicative of the chart comprises transmitting data to display the first text string adjacent to a bar which graphically represents the first sum.

20. A method as defined in claim 1, wherein transmitting the data indicative of the chart comprises transmitting data indicative of a bar graph, wherein the bar graph includes numerical values indicative of the first sum, the second sum, the third sum, and the fourth sum.

21. A method as defined in claim 1, wherein highlighting at least one of the first text string and the second text string in the first document using the first color and highlighting at least one of the third text string and the fourth text string in the first document using the second color to create the first highlighted document comprises highlighting a page description file (PDF).

22. A method as defined in claim 21, wherein the PDF is a searchable PDF.

23. A method as defined in claim 1, wherein highlighting at least one of the first text string and the second text string in the first document using the first color and highlighting at least one of the third text string and the fourth text string in the first document using the second color to create the first highlighted document comprises highlighting a hypertext markup language file (HTML).

24. A method as defined in claim 1, wherein delivering the first highlighted document and the second highlighted document to the user comprises mailing a hard copy of the first highlighted document and the second highlighted document to the user.

25. A method as defined in claim 1, wherein delivering the first highlighted document to the user comprises delivering a searchable PDF file, the searchable PDF file being generated from a patent image file.

26. A method as defined in claim 1, wherein the first document, the second document, the first highlighted document, and the second highlighted document comprise electronic documents.

27. A method as defined in claim 1, further comprising receiving a query date, wherein the query result excludes a patent document because the patent document is associated with a filing date that is after the query date.

28. A method as defined in claim 1, further comprising:
determining a shortest distance in the first document from one of the first text string and the second text string to one of the third text string and the fourth text string; and
indicating the shortest distance to the user.

29. A method as defined in claim 28, further comprising amending the first document to indicate the location of the shortest distance to the user.

30. A method as defined in claim 28, wherein the distance is measured in words.

31. A method as defined in claim 28, wherein the distance is measured in physical distance across the first document.

32. A method as defined in claim 1, further comprising adding a watermark to the first highlighted document and the second highlighted document before delivering the first highlighted document and the second highlighted document to the user.

33. A method as defined in claim 32, wherein the watermark comprises a website address.

34. A method as defined in claim 1, further comprising receiving a patent attorney registration number and using the patent attorney registration number to automatically complete a user input box.

35. A method as defined in claim 1, further comprising receiving a third synonym list from the user, the third synonym list including at least one text string, wherein the first document does not include any of the at least one text string in the third synonym list.

36. A method of searching for prior art, the method comprising:
receiving a first synonym list from a user, the first synonym list including a first text string and a second text string;
receiving a second synonym list from the user, the second synonym list including a third text string and a fourth text string;
executing a database query based on the first synonym list and the second synonym list to produce a query result, the query result identifying a first document and a second document;
adding a number of occurrences of the first text string in the first document and a number of occurrences of the second text string in the first document to contribute to a first sum;
adding a number of occurrences of the third text string in the first document and a number of occurrences of the fourth text string in the first document to contribute to a second sum;
adding a number of occurrences of the first text string in the second document and a number of occurrences of the second text string in the second document to contribute to a third sum;
adding a number of occurrences of the third text string in the second document and a number of occurrences of the fourth text string in the second document to contribute to a fourth sum;
determining a first score associated with the first document, the first score being based on a fifth sum, the fifth sum being based on a first logarithm and a second logarithm, the first logarithm being based on the first sum, the second logarithm being based on the second sum;
determining a second score associated with the second document, the second score being based on a sixth sum, the sixth sum being based on a third logarithm and a fourth logarithm, the third logarithm being based on the third sum, the fourth logarithm being based on the fourth sum; and
ranking the first document relative to the second document based on a comparison of the first score and the second score.

37. A method as defined in claim 36, wherein ranking the first document relative to the second document based on the comparison of the first score and the second score comprises ranking the first document relative to the second document based on a comparison of the first score and the second score if a first number of zero count elements associated with the first document is equal to a second number of zero count elements associated with the second document.

38. A method of searching for prior art, the method comprising:
receiving data indicative of a patent claim from a user;
receiving data indicative of at least a first claim element and a second claim element selected from the patent claim;
executing a database query based on the first claim element and the second claim element to produce a query result, the query result including a first document and a second document;
determining the number of occurrences of the first claim element in the first document to contribute to a first sum;
determining the number of occurrences of the second claim element in the first document to contribute to a second sum;
determining the number of occurrences of the first claim element in the second document to contribute to a third sum;
determining the number of occurrences of the second claim element in the second document to contribute to a fourth sum;
transmitting data indicative of a chart based on the first sum, the second sum, the third sum, and the fourth sum;
highlighting a plurality of occurrences of the first claim element in the first document using a first color and highlighting a plurality of occurrences of the second claim element in the first document using a second color to create a first highlighted document;
highlighting a plurality of occurrences of the first claim element in the second document using the first color and highlighting a plurality of occurrences of the second claim element in the second document using the second color to create a second highlighted document; and
delivering the first highlighted document and the second highlighted document to the user.

39. A method as defined in claim 38, wherein receiving the data indicative of the patent claim from the user comprises receiving a text string representing the patent claim.

40. A method as defined in claim 38, wherein receiving the data indicative of the patent claim from the user comprises receiving a patent number.

41. A method as defined in claim 40, wherein receiving the data indicative of the patent claim from the user comprises receiving a claim number associated with the patent number.

42. A method as defined in claim 41, wherein receiving the data indicative of at least the first claim element and the second claim element selected from the patent claim comprises receiving a word selection from the user.

43. A method as defined in claim 38, further comprising:
determining a first score associated with the first document, the first score being based on a fifth sum, the fifth sum being based on a first logarithm and a second logarithm, the first logarithm being based on the first sum, the second logarithm being based on the second sum;
determining a second score associated with the second document, the second score being based on a sixth sum, the sixth sum being based on a third logarithm and a fourth logarithm, the third logarithm being based on the third sum, the fourth logarithm being based on the fourth sum; and
ranking the first document relative to the second document based on a comparison of the first score and the second score.

44. A method as defined in claim 43, wherein ranking the first document relative to the second document based on the comparison of the first score and the second score comprises ranking the first document relative to the second document based on a comparison of the first score and the second score if a first number of zero count elements associated with the first document is equal to a second number of zero count elements associated with the second document.

45. A method as defined in claim 38, wherein highlighting the first claim element in the second document using the first color and highlighting the second claim element in the second document using the second color to create a second highlighted document comprises highlighting a searchable page description file (PDF).

46. A method as defined in claim 38, wherein the first document is a patent and the second document is a patent, the method further comprising:
hiding a first patent number associated with the first document from the user until a purchase command is received from the user; and
hiding a second patent number associated with the second document from the user until the purchase command is received from the user.

47. A method of searching for prior art, the method comprising:
storing first information associated with a first prior art searcher and second information associated with a second prior art searcher;
receiving an invention description via the Internet;
receiving a category selection associated with the invention description;
selecting the first prior art searcher based on the category selection and the first information associated with the first prior art searcher; and
routing the invention description to the first prior art searcher in response to selecting the first prior art searcher.

48. A method as defined in claim 47, wherein the first prior art searcher comprises at least one of a prior art searching business and a prior art searching agent.

49. A method as defined in claim 47, wherein receiving the invention description comprises receiving a first synonym list indicative of a first claim element and a second synonym list indicative of a second claim element.

50. A method as defined in claim 47, wherein receiving the invention description comprises receiving a plurality of sentences.

51. A method as defined in claim 47, wherein receiving the invention description comprises receiving a diagram.

52. A method as defined in claim 47, wherein receiving the category selection associated with the invention description comprises receiving data indicative of at least one of (i) electrical technology, (ii) software technology, (iii) mechanical technology, (iv) chemical technology, and (v) biological technology.

53. A method as defined in claim 47, further comprising:
routing the invention description to the second prior art searcher;
receiving feedback information associated with the first prior art searcher from the user; and
adjusting a variable associated with the first prior art searcher based on the feedback information.

54. A method as defined in claim 53, wherein selecting the first prior art searcher is further based on the variable.

55. A method as defined in claim 54, wherein receiving feedback information associated with the first prior art searcher from the user comprises receiving an indication that a first set of search results associated with the first prior art searcher was preferred over a second set of search results associated with the second prior art searcher.

56. A method as defined in claim 47, further comprising:
highlighting at least one instance of a first text string and at least one instance of a second text string in a first document using a first color and highlighting at least one instance of a third text string and at least one instance of a fourth text string in the first document using a second color to create a first highlighted document;
highlighting at least one instance of the first text string and at least one instance of the second text string in a second document using the first color and highlighting at least one instance of the third text string and at least one instance of the fourth text string in the second document using the second color to create a second highlighted document; and
delivering the first highlighted document and the second highlighted document to a user.

57. A method of searching for prior art, the method comprising:
storing first routing information associated with a first prior art searcher and second routing information associated with a second prior art searcher;
receiving an invention description via the Internet;
selecting the first prior art searcher instead of the second prior art searcher based on a predefined criteria; and
routing the invention description to the first prior art searcher in response to selecting the first prior art searcher.

58. A method as defined in claim 57, further comprising:
receiving feedback information associated with the first prior art searcher from a user; and
adjusting a variable associated with the first prior art searcher based on the feedback information, wherein selecting the first prior art searcher is based on the variable.

59. A method as defined in claim 58, wherein receiving feedback information associated with the first prior art searcher from the user comprises receiving an indication that a first set of search results associated with the first prior art searcher and the invention description was preferred over a second set of search results associated with the second prior art searcher and the invention description.

60. A method as defined in claim 57, further comprising:
highlighting at least one instance of a first text string and at least one instance of a second text string in a first document using a first color and highlighting at least one instance of a third text string and at least one instance of a fourth text string in the first document using a second color to create a first highlighted document;
highlighting at least one instance of the first text string and at least one instance of the second text string in a second document using the first color and highlighting at least one instance of the third text string and at least one instance of the fourth text string in the second document using the second color to create a second highlighted document; and
delivering the first highlighted document and the second highlighted document to a user.

61. A method of displaying a prior art search website, the method comprising:
storing first data indicative of a first advertisement associated with a first law firm business and second data indicative of a second advertisement associated with a first non-law firm business;
receiving data identifying a first user of the prior art search website;
determining that the first user is employed by a second law firm business;
displaying the second advertisement associated with the first non-law firm business to the first user in response to determining that the first user is employed by the second law firm business;
receiving data identifying a second user of the prior art search website;
determining that the second user is employed by a second non-law firm business; and
displaying the first advertisement associated with the first law firm business to the second user in response to determining that the second user is employed by the second non-law firm business.

62. A method as defined in claim 61, further comprising:
receiving a first synonym list from a third user, the first synonym list including a first text string and a second text string;
receiving a second synonym list from the third user, the second synonym list including a third text string and a fourth text string;
executing a database query based on the first synonym list and the second synonym list to produce a query result, the query result identifying a first document and a second document;
adding a number of occurrences of the first text string in the first document and a number of occurrences of the second text string in the first document to contribute to a first sum;
adding a number of occurrences of the third text string in the first document and a number of occurrences of the fourth text string in the first document to contribute to a second sum;
adding a number of occurrences of the first text string in the second document and a number of occurrences of the second text string in the second document to contribute to a third sum;
adding a number of occurrences of the third text string in the second document and a number of occurrences of the fourth text string in the second document to contribute to a fourth sum;
transmitting data indicative of a chart based on the first sum, the second sum, the third sum, and the fourth sum;
highlighting at least one instance of the first text string and at least one instance of the second text string in the first document using a first color and highlighting at least one instance of the third text string and at least one instance of the fourth text string in the first document using a second color to create a first highlighted document, the first color being different than the second color;
highlighting at least one instance of the first text string and at least one instance of the second text string in the second document using the first color and highlighting at least one instance of the third text string and at least one instance of the fourth text string in the second document using the second color to create a second highlighted document; and
delivering the first highlighted document and the second highlighted document to the third user.

63. A method of searching for prior art, the method comprising:
receiving a first word and a second word associated with a first claim element;
receiving a third word and a fourth word associated with a second claim element;
retrieving a first plurality of synonyms associated with the first word;
retrieving a second plurality of synonyms associated with the second word;
determining a first subset of synonyms based on the first plurality of synonyms and the second plurality of synonyms, wherein a first member of the first subset is selected over a first non-selected synonym because the first member is in the first plurality of synonyms and the second plurality of synonyms, and the first non-selected synonym is not in the second plurality of synonyms;
determining a second subset of synonyms based on the third plurality of synonyms and the fourth plurality of synonyms, wherein a second member of the second subset is selected over a second non-selected synonym because the second member is in the third plurality of synonyms and the fourth plurality of synonyms, and the second non-selected synonym is not in the fourth plurality of synonyms; and
causing at least a portion of the first subset of synonyms and at least a portion of the second subset of synonyms to be displayed to a prior art searcher.

64. A method as defined in claim 63, further comprising:
receiving a first synonym list from the prior art searcher, the first synonym list including a first text string and a second text string;
receiving a second synonym list from the prior art searcher, the second synonym list including a third text string and a fourth text string;
executing a database query based on the first synonym list and the second synonym list to produce a query result, the query result identifying a first document and a second document;
adding a number of occurrences of the first text string in the first document and a number of occurrences of the second text string in the first document to contribute to a first sum;
adding a number of occurrences of the third text string in the first document and a number of occurrences of the fourth text string in the first document to contribute to a second sum;
adding a number of occurrences of the first text string in the second document and a number of occurrences of the second text string in the second document to contribute to a third sum;
adding a number of occurrences of the third text string in the second document and a number of occurrences of the fourth text string in the second document to contribute to a fourth sum;
transmitting data indicative of a chart based on the first sum, the second sum, the third sum, and the fourth sum;
highlighting at least one instance of the first text string and at least one instance of the second text string in the first document using a first color and highlighting at least one instance of the third text string and at least one instance of the fourth text string in the first document using a second color to create a first highlighted document, the first color being different than the second color;
highlighting at least one instance of the first text string and at least one instance of the second text string in the second document using the first color and highlighting at least one instance of the third text string and at least one instance of the fourth text string in the second document using the second color to create a second highlighted document; and
delivering the first highlighted document and the second highlighted document to the prior art searcher.

65. A method as defined in claim 64, further comprising:
determining a first score associated with the first document, the first score being based on a fifth sum, the fifth sum being based on a first logarithm and a second logarithm, the first logarithm being based on the first sum, the second logarithm being based on the second sum;
determining a second score associated with the second document, the second score being based on a sixth sum, the sixth sum being based on a third logarithm and a fourth logarithm, the third logarithm being based on the third sum, the fourth logarithm being based on the fourth sum; and
ranking the first document relative to the second document based on a comparison of the first score and the second score.

66. A method as defined in claim 65, wherein ranking the first document relative to the second document based on the comparison of the first score and the second score comprises ranking the first document relative to the second document based on a comparison of the first score and the second score if a first number of zero count elements associated with the first document is equal to a second number of zero count elements associated with the second document.

67. A method of searching for prior art, the method comprising:
receiving a first synonym list and a second synonym list from a user, the first synonym list being designated as representing a broad scope of a first claim element, the second synonym list being designated as representing a narrow scope of the first claim element;
receiving a third synonym list and a fourth synonym list from the user, the third synonym list being designated as representing a broad scope of a second claim element, the fourth synonym list being designated as representing a narrow scope of the second claim element;
executing a first database query based on a first combination of words from the first synonym list and the third synonym list to produce a first query result, the first combination of words excluding words from the second synonym list and the fourth synonym list, the first query result including a score;
comparing the score to a threshold; and
executing a second database query based on a second combination of words from the first synonym list, the second synonym list, the third synonym list, and the fourth synonym list to produce a second query result.

68. A method as defined in claim 67, further comprising receiving the threshold and a preferred number of documents from the user.

69. A method as defined in claim 67, wherein the score is based on a logarithm of a total number of occurrences of a plurality of words representing the first claim element.
